(19) United States
(12) Patent Application Publication
(10) Pub. No.: US 2021/0029343 A1
(43) Pub. Date: Jan. 28, 2021

(54) INFORMATION PROCESSING DEVICE, METHOD, AND PROGRAM

(71) Applicant: SONY CORPORATION, TOKYO (JP)

(72) Inventors: TOSHIYA HAMADA, TOKYO (JP); KENICHI KANAI, TOKYO (JP)

(21) Appl. No.: 17/040,092

(22) PCT Filed: Dec. 27, 2018
(86) PCT No.: PCT/JP2018/048002

§ 371 Date: Sep. 22, 2020

(30) Foreign Application Priority Data
Mar. 29, 2018 (JP) 2018-065014

(51) Int. Cl. H04N 13/178; H04N 13/282; H04N 13/111

(52) U.S. Cl. CPC H04N 13/178; H04N 13/111; H04N 13/282

(57) ABSTRACT

[Problem] To provide an image processing device, an image processing method, and a program. [Solution] An information processing device that includes a metadata file generating unit that generates a metadata file including viewpoint switch information to perform a position correction of an audio object at a viewpoint switch among plural viewpoints.

### FIELD

The present disclosure relates to an information processing device, a method, and a program.

### BACKGROUND

For the purpose of achieving audio reproduction with a higher sense of realism, for example, MPEG-H 3D Audio has been known as an encoding technique to transmit plural pieces of audio data prepared for each audio object (refer to Non Patent Literature 1).

Plural pieces of encoded audio data are provided to a user, included, for example, in a content file, such as ISO base media file format (ISOBMFF) file, standard of which is defined in Non-Patent Literature 2 below, together with image data.

### CITATION LIST

### Non-Patent Literature

Non Patent Literature 1: “High efficiency coding and media delivery in heterogeneous environments”, ISO/IEC 23008-3: 2015
Non Patent Literature 2: “Coding of audio-visual objects”, ISO/IEC 14496-12: 2014

### SUMMARY

### Technical Problem

On the other hand, a multi-view content enabled to display images while switching viewpoints has recently been becoming common. In sound reproduction of such a multi-view content, there has been a case in which positions of audio objects do not match between before and after a viewpoint switch, to give a sense of awkwardness to a user.

Accordingly, in the present disclosure, an information processing apparatus, an information processing method, and a program that are capable of reducing a sense of awkwardness given to a user by performing a position correction of an audio object at the time of switching viewpoints among plural viewpoints are proposed.

### Solution to Problem

According to the present disclosure, an information processing device is provided that includes: a metadata-file generating unit that generates a metadata file including viewpoint switch information to perform a position correction of an audio object at a viewpoint switch among a plurality of viewpoints.

Moreover, according to the present disclosure, an information processing method is provided that is performed by an information processing device, the method including: generating a metadata file that includes viewpoint switch information to perform a position correction of an audio object at a viewpoint switch among a plurality of viewpoints.

Moreover, according to the present disclosure, a program is provided that causes a computer to implement a function of generating a metadata that includes viewpoint switch information to perform a position correction of an audio object at a viewpoint switch among a plurality of viewpoints.

### Advantageous Effects of Invention

As explained, according to the present disclosure, a sense of awkwardness given to a user can be reduced by performing a position correction of an audio object at the time of switching viewpoints among plural viewpoints.

Note that the effect described above is not limited, and any effect described in the present application, or other effects understood from the present application may be produced together with the above effect, or instead of the above effect.

### BRIEF DESCRIPTION OF DRAWINGS

FIG. 1 is an explanatory diagram for explaining a background of the present disclosure.

FIG. 2 is an explanatory diagram for explaining a position correction of an audio object when a display angle of view varies between a time of creation and a time of reproduction of a content.

FIG. 3 is an explanatory diagram for explaining the position correction of an audio object, following zooming of an image at reproduction.

FIG. 4 is an explanatory diagram for explaining the position correction of an audio object, following zooming of an image at reproduction.

FIG. 5 is an explanatory diagram for explaining position correction of an audio object when a viewpoint switch is not performed.

FIG. 6 is an explanatory diagram for explaining the position correction of an audio object when the viewpoint switch is performed.

FIG. 7 is an explanatory diagram for explaining the position correction of an audio object when a shooting angle of view and a display angle of view at the time of content creation do not coincide with each other.

FIG. 8 is an explanatory diagram for explaining an overview of this technique.

FIG. 9 is a table illustrating one example of multi-view zoom-switch information. Moreover, FIG. 10 is a schematic diagram for explaining the multi-view zoom-switch information.

FIG. 10 is a schematic diagram for explaining the multi-view zoom-switch information.

FIG. 11 is an explanatory diagram for explaining a modification of the multi-view zoom-switch information.

FIG. 12 is an explanatory diagram for explaining a modification of the multi-view zoom-switch information.

FIG. 13 is a flowchart illustrating one example of a generation flow of the multi-view zoom-switch information at the time of content creation.

FIG. 14 is a flowchart illustrating one example of a viewpoint switch flow by using the multi-view zoom-switch information at the time of reproduction.

FIG. 15 is a diagram illustrating a system configuration of an information processing system according to a first embodiment of the present disclosure.

FIG. 16 is a block diagram illustrating a functional configuration example of a generating device 100 according to the present embodiment.

FIG. 17 is a block diagram illustrating a functional configuration example of a distribution server according to the embodiment.

FIG. 18 is a block diagram illustrating a functional configuration example of a client 300 according to the embodiment.

FIG. 19 illustrates a functional configuration example of an image processing unit 320.

FIG. 20 illustrates a functional configuration example of an audio processing unit 330.

FIG. 21 is a diagram for explaining a layer structure of an MPD file, a standard of which is defined by ISO/IEC 23009-1.

FIG. 22 is a diagram illustrating an example of an MPD file that is generated by a metadata-file generating unit 114 according to the embodiment.

FIG. 23 illustrates another example of an MPD file that is generated by the metadata-file generating unit 114 according to the embodiment.

FIG. 24 is a diagram illustrating one example of an MPD file that is generated by the metadata-file generating unit 114 according to a modification of the embodiment.

FIG. 25 is a flowchart illustrating one example of an operation of the generating device 100 according to the embodiment.

FIG. 26 is a flowchart illustrating one example of an operation of the client 300 according to the embodiment.

FIG. 27 is a block diagram illustrating a functional configuration example of a generating device 600 according to a second embodiment of the present disclosure.

FIG. 28 is a block diagram illustrating a functional configuration example of a reproducing device 800 according to the embodiment.

FIG. 29 is a diagram illustrating a box structure of a moov box in an ISOBMFF file.

FIG. 30 is a diagram illustrating an example of a udta box when the multi-view zoom-switch information is stored in the udta box.

FIG. 31 is an explanatory diagram for explaining metadata track.

FIG. 32 is a diagram for explaining the multi-view zoom-switch information stored in the moov box by a content-file generating unit 613.

FIG. 33 is a flowchart illustrating an example of an action of the generating device 600 according to the embodiment.

FIG. 34 is a flowchart illustrating one example of an operation of the reproducing device 800 according to the embodiment.

FIG. 35 is a block diagram illustrating one example of a hardware configuration.

### DESCRIPTION OF EMBODIMENTS

Hereinafter, exemplary embodiments of the present disclosure will be explained in detail with reference to the accompanying drawings. Note that common reference symbols are assigned to components having substantially the same functional configurations throughout the present specification and the drawings, and duplicated explanation will be thereby omitted.

Moreover, in the present application and the drawings, plural components having substantially the same functional configurations can be distinguished thereamong by adding different alphabets at the end of the same reference symbols. However, when it is not necessary to particularly distinguish respective plural components having substantially the same functional configurations, only the same reference symbol is assigned.

Explanation will be given in following order.
<<1. Background>>
<<2. Principle of Present Technique>>
<<3. First Embodiment>>
<<4. Second Embodiment>>
<<5. Hardware Configuration Example>>
<<6. Conclusion>>

### 1. BACKGROUND

Firstly, the explanation is given about the background of the present disclosure.

Multi-view contents enabled to display images while switching viewpoints have recently been becoming common. Such a multi-view content includes not only a two-dimensional image, but also a 360° whole sky image that is taken by a whole sky camera or the like, as images corresponding to respective viewpoints. When a 360° whole sky image is displayed, a partial range is cut out from the whole sky image, and the cut-out display image is displayed based on, for example, an input by a user or a viewing position and direction of a user determined by sensing. Of course, also when a 2D image is displayed, a display image obtained by cutting out a partial range from the 2D image can be displayed.

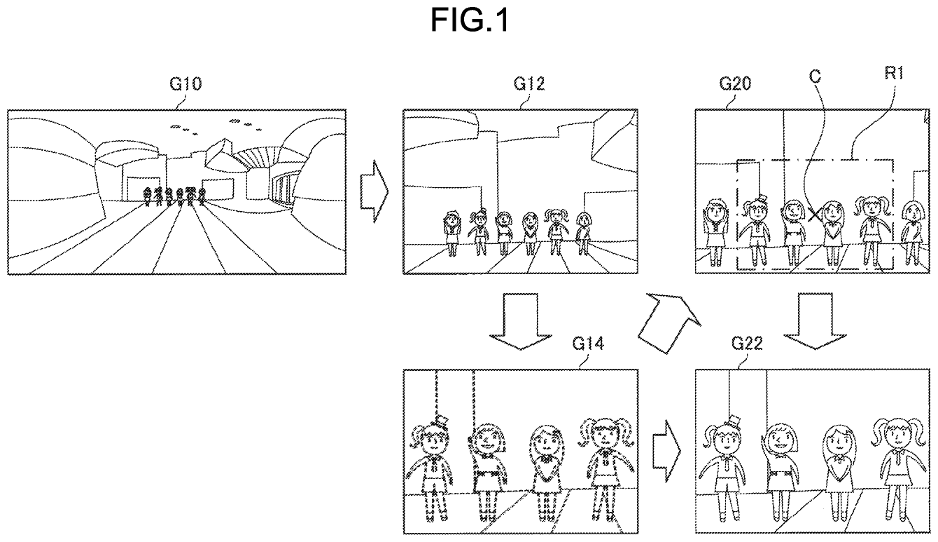

A use case in which a user views such a multi-view content including both a 360° whole sky image and a 2D image while changing a cut-out range for a display image will be explained, referring to FIG. 1. FIG. 1 is an explanatory diagram for explaining a background of the present disclosure.

In the example illustrated in FIG. 1, a 360° whole sky image G10 that is expressed by the equirectangular projection and a 2D image G20 are included in a multi-view content. The 360° whole sky image G10 and the 2D image G20 are images taken from different viewpoints.

Moreover, in FIG. 1, a display image G12 that is obtained by cutting out a partial range from the 360° whole sky image G10 is illustrated. In a state in which the display image G12 is displayed, a display image G14 that is obtained by further cutting out a partial range of the display image G12, for example, by increasing a zoom factor (display magnification) or the like can also be displayed.

When the number of pixels of a display image is smaller than the number of pixels of a display device, enlargement processing is performed to display it. The number of pixels of a display image is determined by the number of pixels of a cut-out source and a size of a cut-out range, and when the number of pixels of the 360° whole sky image G10 is small, or when the size of the range to be cut out for the display image G14 is small, the number of pixels of the display image G14 is to be small also. In such a case, degradation of image quality, such as blurriness, can occur in the display image G14 as illustrated in FIG. 1. Moreover, if the zoom factor is further increased from the display image G14, further degradation of image quality can occur.

When a range corresponding to the display image G14 is contained in the 2D image G20 and the number of pixels of the 2D image G20 is large, switch of viewpoint can be considered. By switching the viewpoint to display the 2D image G20 and then by further increasing the zoom factor or the like, a display image G22 that is obtained by cutting out, from the 2D image G20, a range R1 corresponding to the display image G14 in the 2D image G20 can be displayed. The display image G22 displays the range corresponding to the display image G14, and is expected to cause less degradation in image quality than the display image G14, and to bear viewing in which the zoom factor is further increased.

When a 360° whole sky image is to be displayed, degradation of image quality can occur not only when the zoom factor is large, but also when the zoom factor is small. For example, when the zoom factor is small, a distortion included in a display image that is cut out from a 360° whole sky image can be significantly noticeable. In such a case also, switching to a 2D image is effective.

However, when it is switched to the 2D image G20 from the state in which the display image G14 is displayed, sizes of the subject vary, and a sense of awkwardness can therefore be given to a user. Accordingly, it is preferable that a display be switched directly from the display image G14 to the display image G22 at the time of switching the viewpoints. For example, to switch the display directly from the display image G14 to the display image G22, it is necessary to identify a size and a position of a center C of the range R1 corresponding to the display image G14 in the 2D image G20.

When viewpoints are switched within a 360° whole sky image, a display angle of view (angle of view of zoom factor 1) that enables a subject to be seen about the same as that in the real world can be calculated and, therefore, the sizes of the subject can be matched between before and after the switch.

However, in the case of 2D image, it can be stored in a zoomed state at the time of shoot, but it does not necessarily provide information about angle of view at the time of shoot. In that case, a shot image is to be zoomed in and zoomed out to be displayed on a reproduction side, and a true zoom factor (display angle of view) with respect to the real world of the image currently being displayed is to be what is obtained by multiplying the zoom factor at the time of shoot and a zoom factor at the time of reproduction. When the zoom factor at the time of shoot is unknown, the true zoom factor with respect to the real world of the image currently being displayed is also unknown. Therefore, it becomes impossible to match the sizes of the subject between before and after a switch in the use case of performing viewpoint switch. Note that such a phenomenon can occur at a viewpoint switch between a 360° whole sky image that is enabled to be zoomed or rotated and a 2D image, or between plural 2D images.

To make the subject appear in sizes equivalent to each other between before and after a viewpoint switch, it is necessary to acquire a value of a display magnification of the image before a switch, and to appropriately set a display magnification of the image after the switch to be the same as the value.

A display magnification of an image viewed by a user is determined by three parameters of an angle of view at the time of shoot, a cut-out angle of view from an original image of the display image, and a display angle of view of a display device at the time of reproduction. Moreover, a true display magnification (display angle of view) of an image finally viewed by a user with respect to the real world can be calculated as follows.

True Display Angle of View=(Angle of View at Shoot)×(Cut-Out Angle of view from Original Image of Display Image)×(Display Angle of View of Display Device)

In the case of a 360° whole sky image, the angle of view at the time of shot is 360°. Furthermore, as for a cut-out angle of view, based on the number of pixels in a cut-out range, a corresponding degree of angle of view can be calculated. Moreover, because information about an angle of view of a display device is also determined by a reproduction environment, a final display magnification can be calculated.

On the other hand, in the case of a 2D image, information about an angle of view at the time of shoot cannot be generally obtained, or is often lost curing creation. Moreover, it is possible to acquire a cut-out angle of view as a relative position to the original image, but a corresponding degree of the angle of view as an absolute value in the real world cannot be acquired. Therefore, it is difficult to acquire a final display magnification.

Furthermore, in a viewpoint switch between a 360° whole sky image and a 2D image, it is necessary to match directions of the subject. Accordingly, direction information at the time of shoot of the 2D image is also necessary. If a 360° whole sky image is an image conforming to the omnidirectional media application format (OMAF), direction information is recorded as metadata, but from 2D images, it is common that direction information cannot be acquired therefrom.

As described, to enable to match sizes of a subject between a 360° whole sky image and a 2D image at a viewpoint switch with zooming, information of an angle of view and information of a direction at the time when the 2D image is shot are necessary.

In reproduction of a multi-view content, it is preferable that a position of a sound source (hereinafter, it can be referred to as audio object) of a sound be appropriately changed according to zooming or a viewpoint switch. In MPEG-H 3D Audio described in Non-Patent Literature 1 described above, a mechanism of correcting a position of an audio object corresponding to zooming of an image is defined. Hereinafter, such a mechanism will be explained.

In MPEG-H 3D Audio, following two position correcting functions of an audio object are provided.

(First Correcting Function): A position of an audio object is corrected when a display angle of view at the time of content creation and a display angle of view at the time of reproduction that have been subjected to positioning of an image sound.

(Second Correcting Function): A position of an audio object is corrected, following zooming of an image at the time of reproduction.

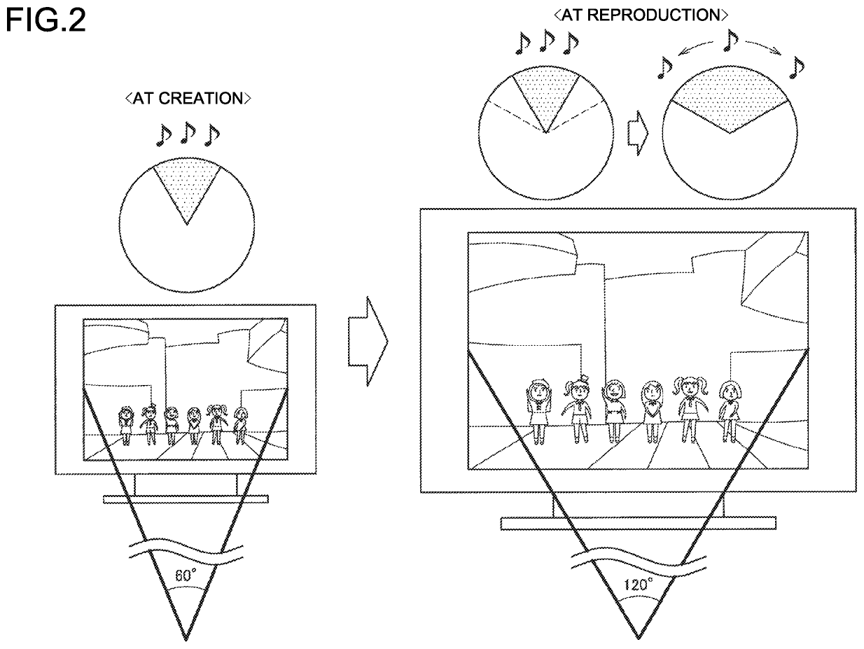

First, the first correcting function described above will be explained, referring to FIG. 2. FIG. 2 is an explanatory diagram for explaining a position correction of an audio object when a display angle of view varies between a time of creation and a time of reproduction of a content. Although an angle of view of an image on a spherical surface and an angle of view on a flat display are different to be precise, to facilitate understanding of the explanation, those are approximated to be handled as identical in the following.

In the example illustrated in FIG. 2, an angle of view at the time of content creation and at the time of reproduction are indicated. In the example illustrated in FIG. 2, an angle of view at the time of content creation is 60°, and an angle of view at the time of reproduction is 120°.

As illustrated in FIG. 2, a content creator determines a position of an audio object while displaying an image of a shooting angle of view of 60° at a display angle of view of 60°. At this time, because the shooting angle of view and the display angle of view are identical, the zoom factor is 1. When a subject image is a 360° whole sky image, a cut-out angle of view (shooting angle of view) can be determined, adjusting to the display angle of view and, therefore, display at the 1-fold zoom factor is easily enabled.

The example of displaying a content thus created at the display angle of view of 120° is illustrated in FIG. 2. When the shooting angle of view of the display image is 60°, an image viewed by a user is to be substantially an enlarged image. In MPEG-H 3D Audio, information to perform correction, adjusting a position of an audio object to this enlarge image and API are defined.

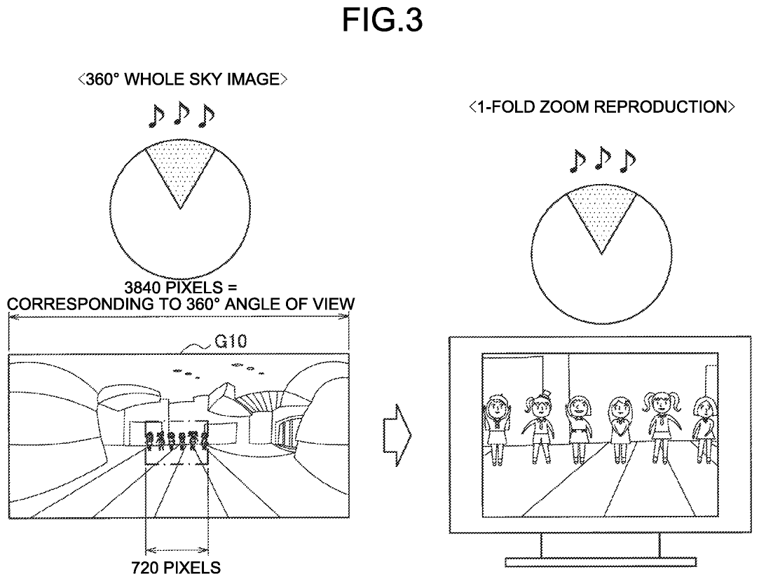

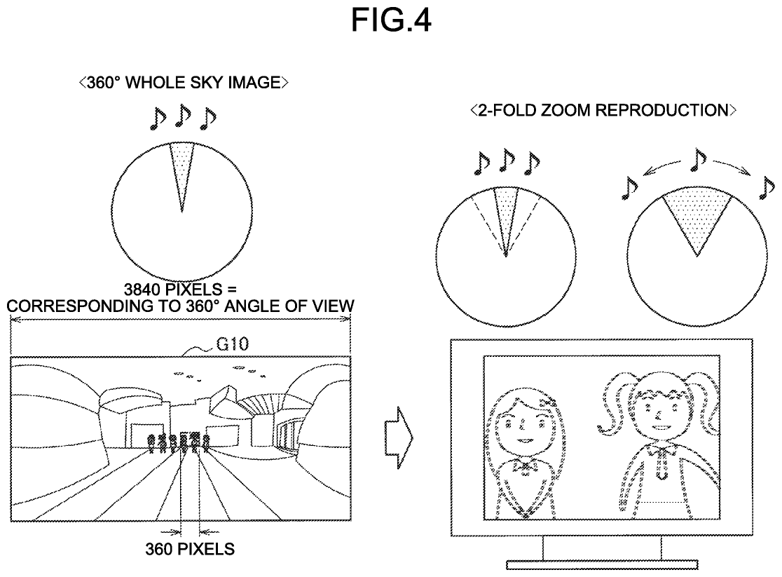

Subsequently, the second correcting function described above will be explained, referring to FIG. 3 and FIG. 4. FIG. 3, FIG. 4 are explanatory diagrams for explaining the position correction of an audio object, following zooming of an image at reproduction. The number of horizontal pixels of the 360° whole sky image G10 illustrated in FIG. 3, FIG. 4 is 3840 pixels, and this corresponds to the angle of view of 360°. Moreover, the zoom factor at the time of shoot of the 360° whole sky image G10 is 1. Furthermore, it is assumed that a position of the audio object is set corresponding to the 360° whole sky image G10. Moreover, for simplicity, display angles of view at the time of content creation and at the time of reproduction of a content are identical, and the position correction of an audio object at the time of creation as explained referring to FIG. 2 is not necessary, and only correction necessitated by zoomed display at the time of reproduction is performed.

FIG. 3 illustrates an example in which reproduction is performed at the 1-fold zoom factor. When the display angle of view at the time of reproduction is 67.5°, by cutting out a range of 720 pixels corresponding to the shooting angle of image 67.5° out of the 360° whole sky image G10 to be displayed as illustrated in FIG. 3, display at the 1-fold zoom factor is enabled. As described, when reproduction is performed at the 1-fold zoom factor, the position correction of an audio object is unnecessary.

FIG. 4 illustrates an example in which reproduction is performed at the 2-fold zoom factor. When the display angle of view at the time of reproduction is 67.5°, by cutting out and displaying a range of 360 pixels corresponding to the shooting angle of image 33.75° out of the 360° whole sky image G10 as illustrated in FIG. 4, display at the 2-fold zoom factor is enabled. Information to perform the position correction, adjusting a position of an audio object to the zoom factor of the image and API are defined in MPEG-H 3D Audio.

In MPEG-H 3D Audio, the two position correcting functions of an audio object as explained above are provided. However, with the position correcting functions of an audio object provided in the MPEG-H 3D Audio described above, there is a case in which a position correction of an audio object when a viewpoint switch is performed along with zooming cannot be performed appropriately.

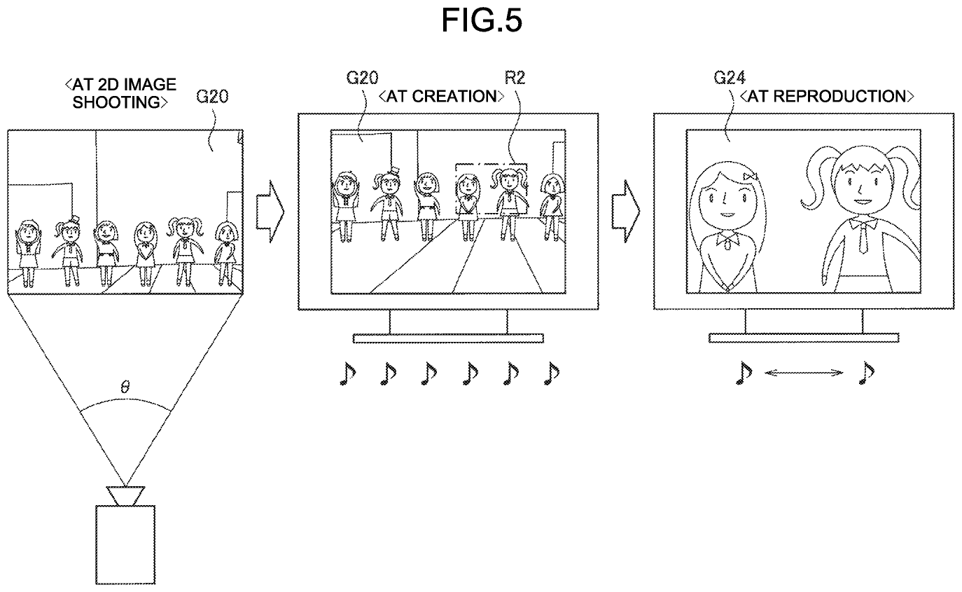

A position correction of an audio object necessary in a use case assuming a viewpoint switch performed along with zooming will be explained, referring to FIG. 5 to FIG. 7.

FIG. 5 is an explanatory diagram for explaining the position correction of an audio object when a viewpoint switch is not performed. As illustrated in FIG. 5, the angle of view at the time of shoot of the 2D image G20 is 0. It is supposed that information about the shooting angle of view θ cannot be acquired at the time of content creation and at the time of reproduction in the example illustrated in FIG. 5.

In the example illustrated in FIG. 5, at the time of content creation, the display angle of view is 90°, and the 2D image G20 is displayed as it is at the 1-fold zoom factor. Because the shooting angle of view θ cannot be acquired at the time of content creation, a true display magnification with respect to the real world is unknown.

In the example illustrated in FIG. 5, the display angle of view is 60° at the time of reproduction, and a display image G24 is displayed at the 2-fold zoom factor, for example, by cutting out a range R2 indicated in FIG. 5. Because the shooting angle of view θ cannot be acquired at the time of reproduction, a true display magnification with respect to the real world is unknown. However, when an image of an identical viewpoint is displayed, even if the true display magnification is unknown, correction of a position of an audio object can be performed by using the position correcting function of an audio object provided in MPEG-H 3D Audio described above. Therefore, it is possible to perform reproduction maintaining relative positional relation between the image and a sound.

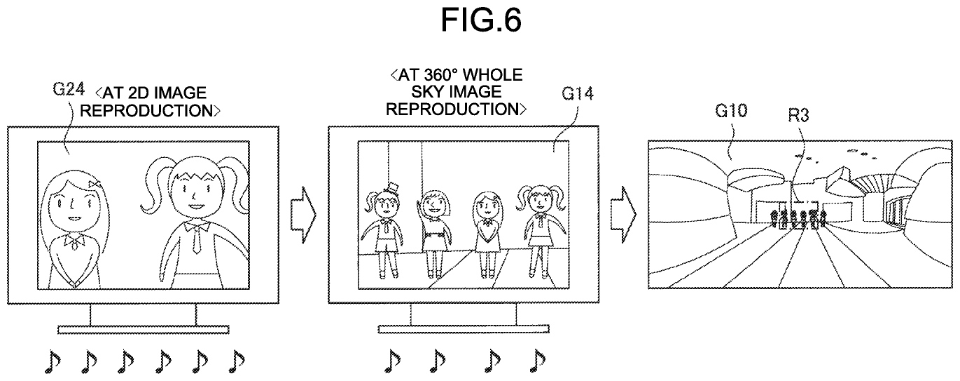

FIG. 6 is an explanatory diagram for explaining the position correction of an audio object when the viewpoint switch is performed. In the example illustrated in FIG. 6, the viewpoint switch can be performed between a 360° whole sky image and a 2D image.

In the example illustrated in FIG. 6, the display angle of view is 60° at the time of reproduction of the 2D image similarly to the example illustrated in FIG. 5, and the display image G24 that is obtained by cutting out from the 2D image at the 2-fold zoom factor is displayed. Moreover, similarly to the example illustrated in FIG. 5, because the shooting angle of view θ cannot be acquired as described above, a true display magnification with respect to the real world is unknown.

Furthermore, performing a viewpoint switch with respect to the 360° whole sky image in the example illustrated in FIG. 6 is considered. Because the display angle of view does not change, the display angle of view is 60°. When display maintaining the 2-fold zoom factor is attempted at the time of reproduction of the 360° whole sky image, for example, a display image G14 that is obtained by cutting out a range R3 at the cut-out angle of view of 30° from the 360° whole sky image G10 can be displayed. The zoom factor at the time of reproduction of the 360° whole sky image is also a true display magnification with respect to the real world, and a true display magnification with respect to the real world is 2-fold.

However, as described above, a true display magnification with respect to the real world at the time of reproduction of a 2D image is unknown, and the true display magnification with respect to the real world at the time of reproduction of the 2D image and the true display magnification with respect to the real world at the time of reproduction of the 360° whole sky image do not necessarily coincide with each other by the viewpoint switch as described above. Therefore, by the viewpoint switch as described above, sizes of a subject do not match.

Moreover, as for the position of an audio object also, a mismatch can occur between before and after the viewpoint switch, and a sense of awkwardness can be given to the user. Therefore, it is preferable that correction to match positions of an audio object also be performed between before and after a viewpoint switch, along with matching sizes of a subject.

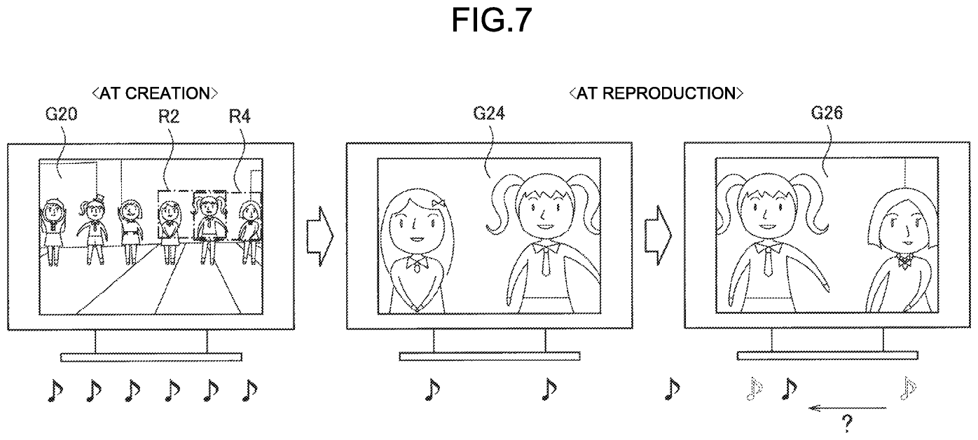

FIG. 7 is an explanatory diagram for explaining the position correction of an audio object when a shooting angle of view and a display angle of view at the time of content creation do not coincide with each other.

In the example illustrated in FIG. 7, the display angle of view is 80° at the time of content creation, and the 2D image G20 is displayed as it is at the 1-fold zoom factor. A true display magnification with respect to the real world is unknown. Accordingly, the shooting angle of view and the display angle of view at the time of content creation do not necessarily coincide with each other. Because the shooting angle of view is unknown, a true display magnification with respect to the real world is unknown, but there is a possibility that the position of the audio object has been determined based on an image at such a zoom factor that the true display magnification with respect to the real world is not 1.

Furthermore, in the example illustrated in FIG. 7, suppose that the display angle of view is 60° at the time of reproduction, and display is performed at the 2-fold zoom factor. Moreover, the shooting angle of view at the time of reproduction is also unknown. Accordingly, the true display magnification with respect to the real world is unknown.

Furthermore, in FIG. 7, an example in which a cut-out range is moved while maintaining the 2-fold zoom factor at the time of reproduction is illustrated. In FIG. 7, the example in which the display image G24 that is obtained by cutting out the range R2 of the 2D image G20, and the example in which a display image G26 that is obtained by cutting out a range R4 of the 2D image G20 are illustrated.

As described above, when a position of an audio object is determined based on an image at such a zoom factor that the true display magnification with respect to the real world is not 1 fold, the display image G24 to be displayed at the time of reproduction, and a rotation angle of the display image G24 with respect to the real world are unknown. Accordingly, a moving angle of the audio object that is moved in accordance with a move of the cut-out range with respect to the real world is also unknown.

However, when it is transitioned from a state in which the display image G24 is displayed to a state in which the display image G26 is displayed, it is possible to correct the position of the audio object by using the position correcting function of an audio object provided in MPEG-H 3D Audio as explained referring to FIG. 5. As described, for images of an identical viewpoint, the position correction of an audio object is possible even if a moving angle with respect to the real world is unknown. However, when it is switched to another viewpoint, position correction of an audio object is difficult if the rotation angle with respect to the real world is unknown. As a result, positions of a sound are not matched between before and after a viewpoint switch, and a sense of awkwardness can be given to a user.

### 2. PRINCIPLE OF PRESENT TECHNIQUE

Focusing on the circumstances described above, respective embodiments according to the present disclosure have been achieved. According to the respective embodiments explained hereinafter, it is possible to reduce a sense of awkwardness given to a user by performing position correction of an audio object at a viewpoint switch among multiple viewpoints. In the following, a basic principle of the technique according to the present disclosure (hereinafter, also referred to as present technique) common among the respective embodiments of the present disclosure will be explained.

<<2-1. Overview of Present Technique>>

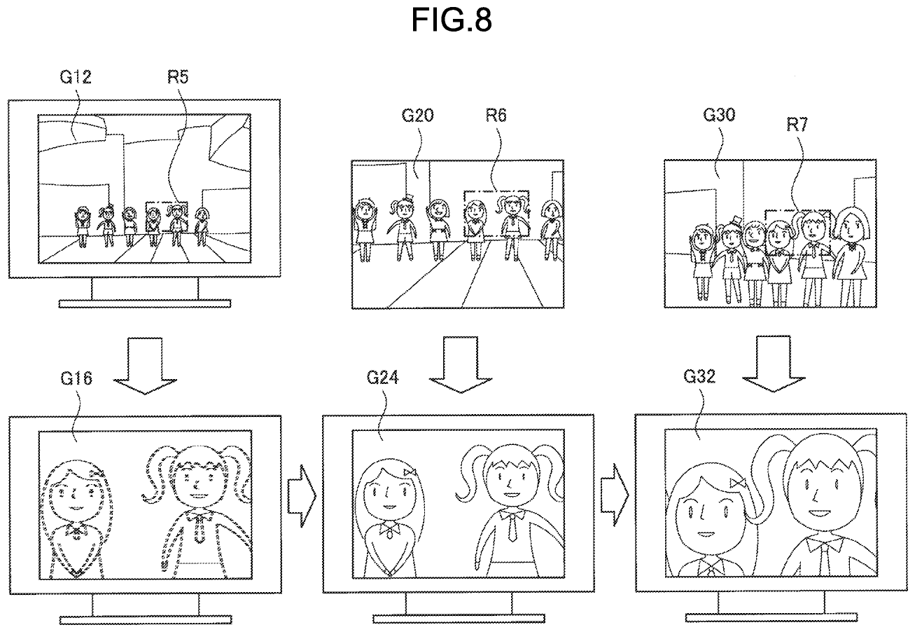

FIG. 8 is an explanatory diagram for explaining an overview of this technique. FIG. 8 illustrates the display image G12, the 2D image G20, and a 2D image G30. The display image G12 may be an image cut out from a 360° whole sky image as explained referring to FIG. 1. The 360° whole sky image subjected to cut-out of the display image G12, the 2D image G20, and the 2D image G30 are images shot from respective different viewpoints.

When a display image G16 that is obtained by cutting out a range R5 of the display image G12 is displayed from a state in which the display image G12 is displayed, deterioration of an image quality can occur. Therefore, a viewpoint switch to a viewpoint of the 2D image G20 is considered to be performed. At this time, in the present technique, a range R6 corresponding to the display image G16 in the 2D image G20 is automatically identified, and the display image G24 in which the size of the subject is kept is thereby displayed, without displaying the entire portion of the 2D image G20. Furthermore, in the present technique, also when a viewpoint switch from the viewpoint of the 2D image G20 to the 2D image G30, the size of the subject is kept. In the example illustrated in FIG. 8, by identifying a range R7 corresponding to the display image G24 in the 2D image G30, a display image G32 in which the size of the subject is kept is displayed without displaying the entire portion of the 2D image G30, also at the time when switched from a viewpoint of the 2D image G20 to a viewpoint of the 2D image G30. According to such a configuration, a sense of awkwardness given to vision of a user can be reduced.

Moreover, in the present technique, at the viewpoint switch described above, the position correction of an audio object is performed, and reproduction is performed at a position of a sound source according to the viewpoint switch. According to such a configuration, a sense of awkwardness given to a sense of hearing of a user can be reduced.

To achieve the effects explained referring to FIG. 8, in the present technique, information to perform the viewpoint switch described above at the time of content creation is prepared, and the information is shared at the time of content creation file, and at the time of reproduction also. In the following, the information to perform the viewpoint switch is referred to as multi-view zoom-switch information, or simply as viewpoint switch information. The multi-view zoom-switch information is information to perform display while keeping a size of a subject at the time of a viewpoint switch among plural viewpoints. Furthermore, the multi-view zoom-switch information is also information to perform position correction of an audio object at the time of viewpoint switch among plural viewpoints. Hereinafter, the multi-view zoom-switch information will be explained.

<<2-2. Multi-View Zoom-Switch Information>>

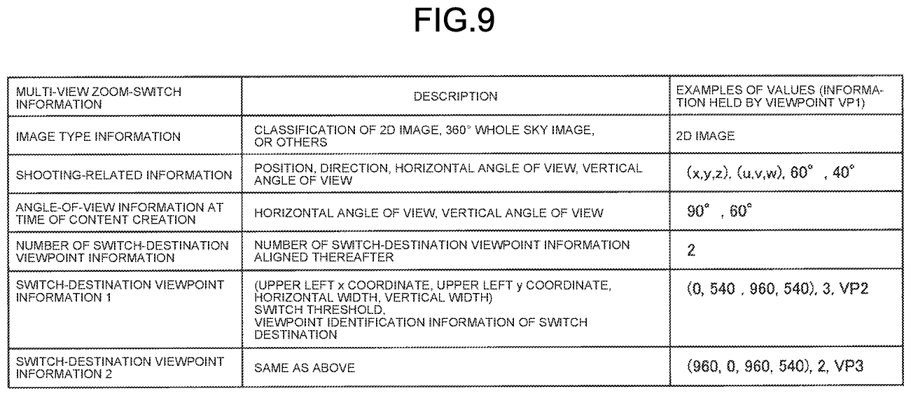

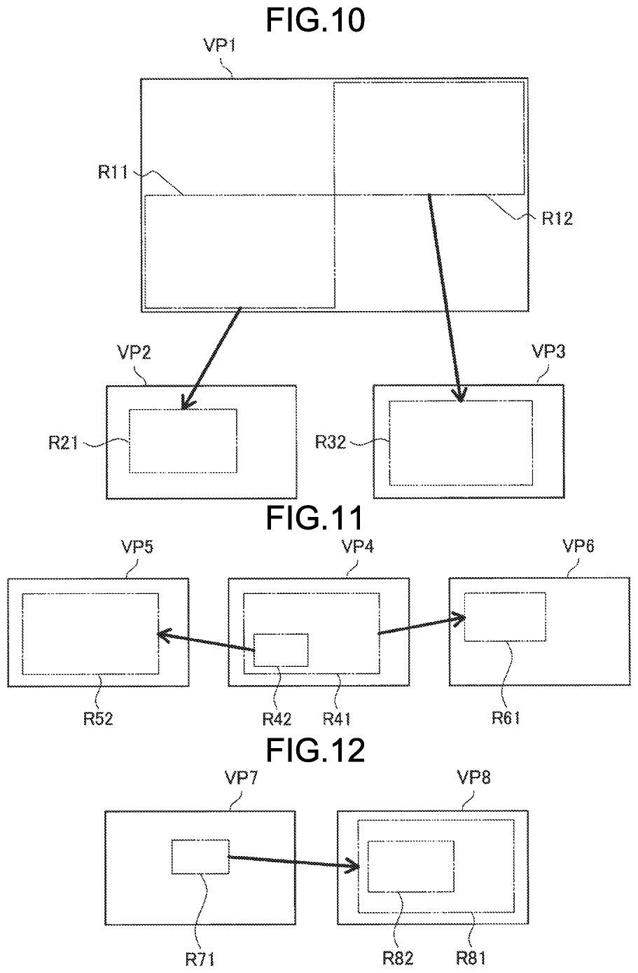

One example of the multi-view zoom-switch information will be explained, referring to FIG. 9, FIG. 10. FIG. 9 is a table illustrating one example of multi-view zoom-switch information. Moreover, FIG. 10 is a schematic diagram for explaining the multi-view zoom-switch information.

As illustrated in FIG. 9, the multi-view zoom-switch information may include image type information, shooting-related information, angle-of-view information at the time of content creation, the number of switch-destination viewpoint information, and switch-destination viewpoint information. The multi-view zoom-switch information illustrated in FIG. 9 may be prepared, for example, associating with each viewpoint included in a multi-view content. In FIG. 9, the multi-view zoom-switch information associated with a viewpoint VP indicated in FIG. 10 is illustrated as an example of values.

The image type information is information indicating a type of image related to a viewpoint associated with the multi-view zoom-switch information, and can be, for example, a 2D image, a 360° whole sky image, others, or the like.

The shooting-related information is information about a time of shoot of an image relating to a viewpoint associated with the multi-view zoom-switch information. For example, the shooting-related information includes shooting position information relating to a position of a camera used to take the image. Moreover, the shooting-related information includes shooting direction information relating to a direction of a camera used to take the image. Furthermore, the shooting-related information includes shooting angle-of-view information relating to an angle of view (horizontal angle of view, vertical angle of view) of the camera used to take the image.

The angle-of-view information at the time of content creation is information of a display angle of view (horizontal angle of view, vertical angle of view) at the time of content creation. The angle-of-view information at the time of content creation is also reference angle-of-view information relating to an angle of view of a screen that is referred to when position information of an audio object relating to a viewpoint associated with the viewpoint switch information. Moreover, the angle-of-view information at the time of content creation is may be information corresponding to mae_ProductionScreenSizeData( ) in MPEG-H 3D Audio.

By using the shooting-related information, and the angle-of-view information at the time of content creation, display while keeping a size of a subject is enabled, and the position correction of an audio object is enabled.

The switch-destination viewpoint information is information relating to a switch destination viewpoint to which the viewpoint associated with the multi-view zoom-switch information can be switched. As illustrated in FIG. 9, the multi-view zoom-switch information includes the number of switch-destination viewpoint information aligned thereafter, and a viewpoint VP1 indicated in FIG. 10 is switchable to two viewpoints, a viewpoint VP2 and a viewpoint VP3.

The switch-destination viewpoint information may be, for example, information to switch to a switch destination viewpoint. In the example illustrated in FIG. 9, the switch-destination viewpoint information includes information relating to a region subject to viewpoint switch (upper left x coordinate, upper left y coordinate, horizontal width, vertical width), threshold information relating to a switch threshold, and viewpoint identification information of a switch destination.

For example, in the example illustrated in FIG. 10, a region to switch from the viewpoint VP1 to the viewpoint VP2 is R11. The region R11 of the viewpoint VP1 corresponds to a region R21 of VP2. Moreover, in the example illustrated in FIG. 10, a region to switch from the viewpoint VP1 to the viewpoint VP2 is a region R12. The region R12 of the viewpoint VP1 corresponds to the region R32 of VP2.

The threshold information may be information of a threshold of, for example, a maximum display magnification. For example, in the region R11 of the viewpoint VP1, when the display magnification becomes 3-fold or larger, the viewpoint switch to the viewpoint VP2 is performed. Moreover, in the region R12 of the viewpoint VP1, when the display magnification becomes 2-fold or larger, the viewpoint switch to the viewpoint VP3 is performed.

As above, one example of the switch-destination viewpoint information has been explained, referring to FIG. 9 and FIG. 10, but information included in the switch-destination viewpoint information is not limited to the example described above. In the following, some modifications of the switch-destination viewpoint information will be explained. FIG. 11, FIG. 12 are explanatory diagrams for explaining those modifications.

For example, the switch-destination viewpoint information may be set in multiple stages. Furthermore, the switch-destination viewpoint information may be set such that viewpoints are mutually switchable. For example, it may be set such that the viewpoint VP1 and the viewpoint VP2 can be mutually switched, and the viewpoint VP1 and the viewpoint VP3 can be mutually switched.

Moreover, the switch-destination viewpoint information may be set such that different paths can be taken among viewpoints. For example, it may be set such that it can be switched from the viewpoint VP1 to the viewpoint VP2, and from the viewpoint VP2 to the viewpoint VP3, and from the viewpoint VP3 to the viewpoint VP1.

Furthermore, when viewpoints are mutually switchable, a hysteresis may be provided in the switch-destination viewpoint information by varying the threshold information depending on a direction of switch. For example, it may be set such that a threshold of that from the viewpoint VP1 to the viewpoint VP2 is 3-fold, and a threshold of that from the viewpoint VP2 to the viewpoint VP1 is 2-fold. According to such a configuration, complicated viewpoint switch is less likely to occur, and a sense of awkwardness given to a user can be further reduced.

Moreover, regions in the switch-destination viewpoint information may overlap each other. In the example illustrated in FIG. 11, it can be switched from a viewpoint VP4 to a viewpoint VP5, or to a viewpoint VP6. A region R41 in the viewpoint VP4 to switch to a region 61 of the viewpoint VP6 from the viewpoint VP 4 includes a region R42 in the viewpoint VP4 to switch from the viewpoint VP4 to a region R52 of the viewpoint VP5, and the regions overlap each other.

Furthermore, the threshold information included in the switch-destination viewpoint information may be information of a minimum display magnification, not just the maximum display magnification. For example, in the example illustrated in FIG. 11, because the viewpoint VP6 is a viewpoint more zoomed out than the viewpoint VP4, the threshold information for a switch from the region R41 of the viewpoint VP4 to a region R61 of the viewpoint VP6 may be information of a minimum display magnification. According to such a configuration, it becomes possible to notify of an intention of a content creator to display in what display magnification at that viewpoint, or to perform a viewpoint switch when the display magnification is exceeded, to a reproduction side.

Moreover, the maximum display magnification or the minimum display magnification may be set in a region having no switch destination viewpoint. In such a case, a zoom change may be stopped at the maximum display magnification or at the minimum display magnification.

Furthermore, when an image subject to the viewpoint switch is a 2D image, the switch-destination viewpoint information may include information of a default initial display range to be displayed right after the switch. As described later, while a display magnification and the like at a switch destination viewpoint can be calculated, a default range to be displayed intentionally by a content creator may be configurable for each switch destination viewpoint. For example, in the example illustrated in FIG. 12, when it is switched from a region R71 of a viewpoint VP7 to a viewpoint VP8, a cut-out range in which a subject is displayed in a size equivalent to that before the switch is a region R82, but a region R81 that is the initial display range may be displayed. When the switch-destination viewpoint information includes the information of an initial display range, the switch-destination viewpoint information may include information of a cut-out center corresponding to the initial display range and a display magnification, in addition to the information relating to a region, the threshold information, and the viewpoint identification information described above.

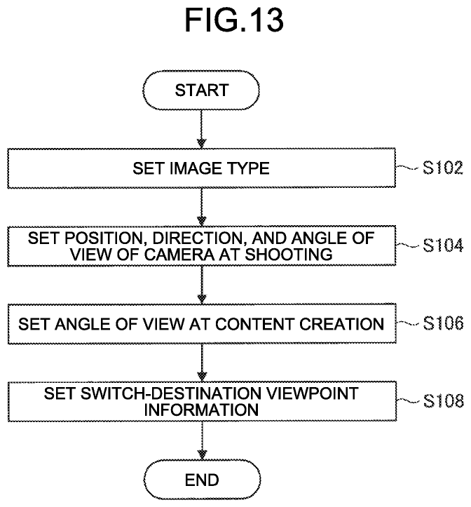

FIG. 13 is a flowchart illustrating one example of a generation flow of the multi-view zoom-switch information at the time of content creation. First, generation of the multi-view zoom-switch information illustrated in FIG. 13 can be performed per viewpoint included in a multi-view content by operating a device for content creation in respective embodiment of the present disclosure by a content creator at the time of content creation.

First, an image type is set, and the information is added (S102). Subsequently, a position, a direction, and an angle of view of a camera at shooting are set, and the shooting-related information is added (S104). At step S104, the shooting-related information may be set by referring to a camera position, a direction, and a zoom value at the time of shoot, a 360° whole sky image being shot at the same time, and the like.

Subsequently, an angle of view at the time of content creation is set, and the angle-of-view information at the time of content creation is added (S106). As described above, the angle-of-view information at the time of content creation is a screen size (display angle of view of a screen) referred to when a position of an audio object is determined. For example, to eliminate an influence of misregistration caused by zooming, full-screen display may be applied without cutting out an image, at the time of content creation.

Subsequently, the switch-destination viewpoint information is set (S108). The content creator sets a region in an image corresponding to each viewpoint, and sets a threshold of a display magnification at which the viewpoint switch occurs, and identification information of a viewpoint switch destination.

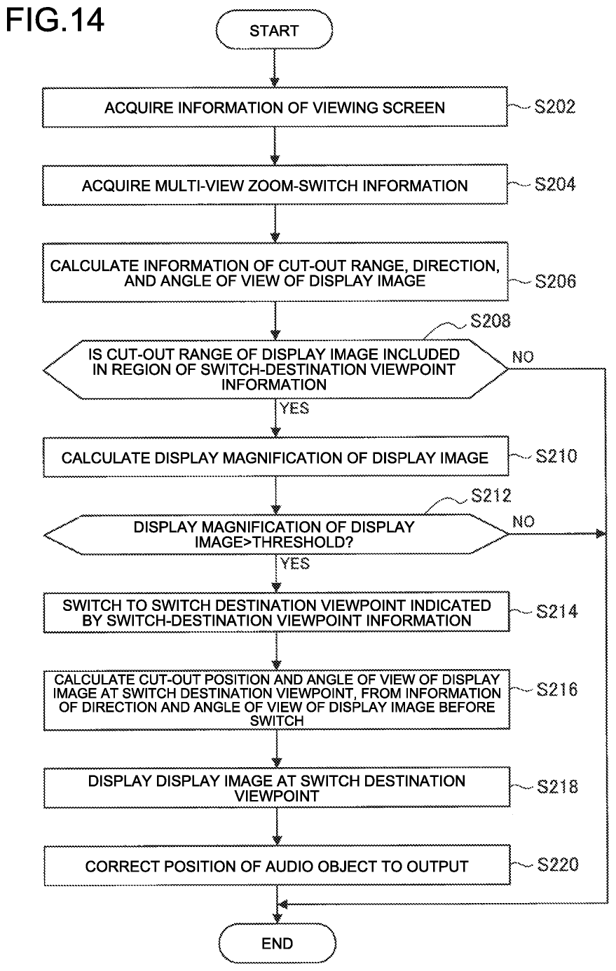

As above, the generation flow of the multi-view zoom-switch information at the time of content creation has been explained. The generated multi-view zoom-switch information is included in a content file or a metadata file as described later, and is provided to a device that performs reproduction in the respective embodiments of the present disclosure. In the following, a viewpoint switch flow using the multi-view zoom-switch information at the time of reproduction will be explained, referring to FIG. 14. FIG. 14 is a flowchart illustrating one example of a viewpoint switch flow by using the multi-view zoom-switch information at the time of reproduction.

First, information of a viewing screen that is used for reproduction is acquired (S202). The information of a viewing screen may be a display angle of view from a viewing position, and can be uniquely determined by a reproduction environment.

Subsequently, the multi-view zoom-switch information relating to a viewpoint of an image currently being displayed is acquired (S204). The multi-view zoom-switch information is stored in a metadata file or a content file as described later. An acquisition method of the multi-view zoom-switch information in the respective embodiment of the present disclosure will be explained later.

Subsequently, information of a cut-out range of a display image, a direction of the display image, and an angle of view are calculated (S208). The information of a cut-out range of the display image may include, for example, information of a center position and a size of the cut-out range.

Subsequently, it is determined whether the cut-out range of the display image calculated at S208 is included in any of regions of the switch-destination viewpoint information included in the multi-view zoom-switch information (S210). When the cut-out range of the display image is not included in any region (NO at S210), the viewpoint switch is not performed, and the flow is ended.

Subsequently, a display magnification of the display image is calculated (S210). For example, the display magnification can be calculated based on the information of a size of the image before the cut-out and the cut-out range of the display image. Subsequently, the display magnification of the display image is compared with the threshold of the display magnification included in the switch-destination viewpoint information (S212). In the example illustrated in FIG. 14, the threshold information indicates the maximum display magnification. When the display magnification of the display image is equal to or smaller than the threshold (NO at S212), the viewpoint switch is not performed, and the flow is ended.

On the other hand, when the display magnification of the display image is larger than the threshold (YES at S212), the viewpoint switch to a switch destination viewpoint indicated by the switch-destination viewpoint information is started (S214). A cut-out position and an angle of view of the display image at the switch destination viewpoint are calculated based on the information of a direction and an angle of view of the display image before the switch, the shooting-related information included in the multi-view zoom-switch information, and the angle-of-view information at the time of content creation (S216).

The display image at the switch destination viewpoint is cutout to be displayed based on the information of the cut-out position and the angle of view calculated at step S216 (S218). Moreover, a position of an audio object is corrected based on the information of the cut-out position and the angle of view calculated at step S216, to be audio-output (S220).

As above, the basic principle of the present technique common among the respective embodiments of the present disclosure have been explained. Subsequently, the respective embodiments of the present disclosure will be specifically explained in the following.

### 3. FIRST EMBODIMENT

<3-1. Configuration Example>

(System Configuration)

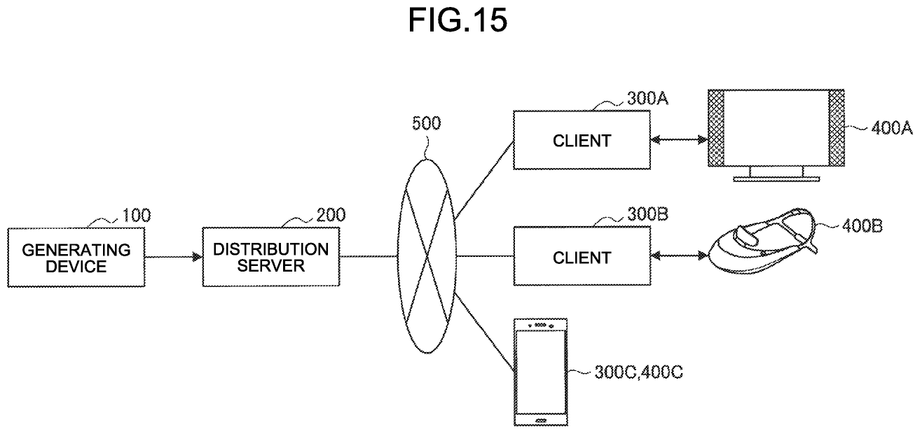

FIG. 15 is a diagram illustrating a system configuration of an information processing system according to a first embodiment of the present disclosure. The information processing system according to the present embodiment illustrated in FIG. 15 is a system that streams multi-view contents, and may perform streaming distribution, for example, by MPEG-DASH, a standard of which is defined by ISO/IEC 23009-1. As illustrated in FIG. 15, the information processing system according to the present embodiment includes a generating device 100, a distribution server 200, a client 300, and an output device 400. The distribution server 200 and the client 300 are connected to each other through a communication network 500.

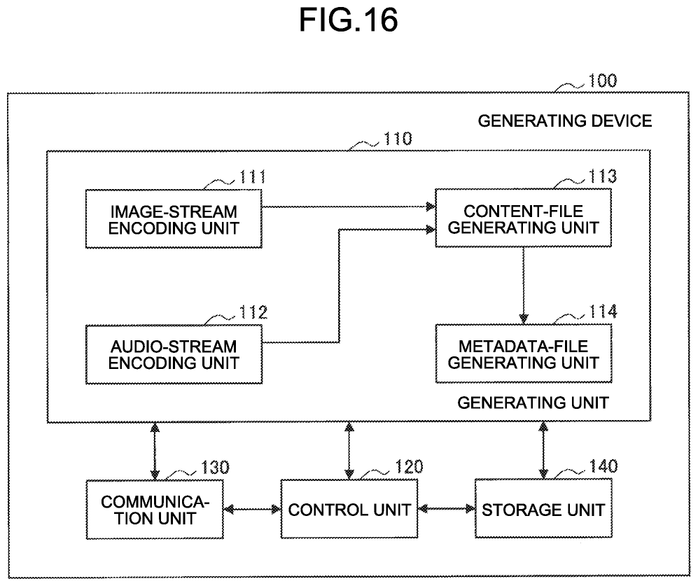

The generating device 100 is an information processing device that generates a content file and a metadata file that are adaptive to streaming by MPEG-DASH. The generating device 100 according to the present embodiment may be used for content creation (position determination of an audio object), or may receive an image signal, an audio signal, and position information of an audio object from another device for content creation. A configuration of the generating device 100 will be described later, referring to FIG. 16.

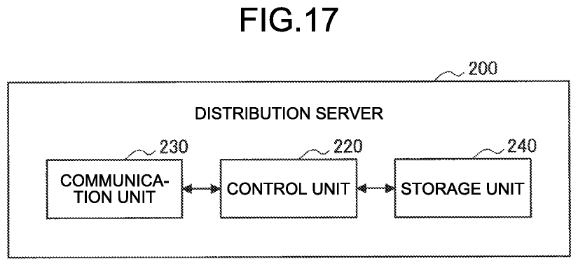

The distribution server 200 functions as an HTTP server, and is an information processing device that performs streaming by MPEG-DASH. For example, the distribution server 200 performs streaming of a content file and a metadata file generated by the generating device 100 to the client 300 based on MPEG-DASH. A configuration of the distribution server 200 will be described later, referring to FIG. 17.

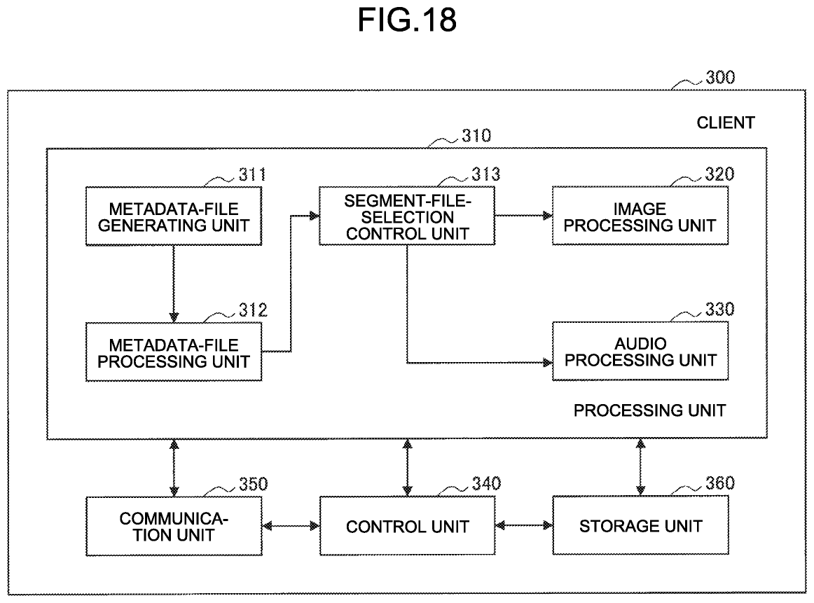

The client 300 is an information processing device that receives the content file and the metadata file generated by the generating device 100 from the distribution server 200, and performs reproduction thereof. FIG. 15 illustrates a client 300A that is connected to an output device 400A of a ground-mounted type, a client 300B that is connected to an output device 400B mounted on a user, and a client 300C that is a terminal having a function as an output device 400C also, as an example of the client 300. A configuration of the client 300 will be described later, referring to FIG. 18 to FIG. 20.

The output device 400 is a device that displays a display image and performs audio output by a reproduction control of the client 300. FIG. 15 illustrates an output device 400A of a ground-mounted type, an output device 400B mounted on a user, and an output device 400C that is a device having a function as the client 300C also, as an example of the output device 400.

The output device 400A may be, for example, a television, or the like. A user may be able to perform operation, such as zooming and rotation, through a controller and the like connected to the output device 400A, and information of the operation can be transmitted from the output device 400A to the client 300A.

Moreover, the output device 400B may be a head mounted display (HMD) that is mounted on a user's head. The output device 400B has a sensor to acquire information, such as a position and an orientation (posture) of the head of the user on which it is mounted, and the information can be transmitted from the output device 400B to the client 300B.

Furthermore, the output device 400C is a mobile display terminal, such as a smartphone and a tablet, and has a sensor to acquire information, such as a position and an orientation (posture) when, for example, the user holds in a hand and moves the output device 400C.

As above, the system configuration example of the information processing system according to the present embodiment has been explained. The above configuration explained referring to FIG. 15 is only one example, and the information processing system according to the present embodiment is not limited to the example. For example, a part of the generating device 100 may be provided in the distribution server 200 or another external device. The information processing system according to the present embodiment is flexibly changeable according to a specification and a use.

(Functional Configuration of Generating Device)

FIG. 16 is a block diagram illustrating a functional configuration example of the generating device 100 according to the present embodiment. As illustrated in FIG. 16, the generating device 100 according to the present embodiment includes a generating unit 110, a control unit 120, a communication unit 130, and a storage unit 140.

The generating unit 110 performs processing related to an image and an audio object, and generates a content file and a metadata file. As illustrated in FIG. 16, the generating unit 110 has functions as an image-stream encoding unit 111, an audio-stream encoding unit 112, a content-file generating unit 113, and a metadata-file generating unit 114.

The image-stream encoding unit 111 acquires an image signal of multiple viewpoints (multi-view image signal), and a parameter at shooting (for example, the shooting-related information) from another device through the communication unit 130, or from the storage unit 140 in the generating device 100, and performs encoding processing. The image-stream encoding unit 111 outputs an image stream and the parameter at the shooting to the content-file generating unit 113.

The audio-stream encoding unit 112 acquires an audio object signal and position information of respective audio objects from another device through the communication unit 130, or from the storage unit 140 in the generating device 100, and performs encoding processing. The audio-stream encoding unit 112 outputs the audio stream to the content-file generating unit 113.

The content-file generating unit 113 generates a content file based on the information provided from the image-stream encoding unit 111 and the audio-stream encoding unit 112. The content file generated by the content-file generating unit 113 may be, for example, an MP4 file, and in the following, an example in which the content-file generating unit 113 generates an MP4 file will be mainly explained. In the present embodiment, the MP4 file may be an ISO Base Media File Format (ISOBMFF) file, a standard of which is defined by ISO/IEC 14496-12.

The MP4 file generated by the content-file generating unit 113 may be a segment file that is data un a unit possible to be distributed by MPEG-DASH.

The content-file generating unit 113 outputs the generated MP4 file to the communication unit 130 and the metadata-file generating unit 114.

The metadata-file generating unit 114 generates a metadata file including the multi-view zoom-switch information described above based on the MP4 file generated by the content-file generating unit 113. Moreover, a metadata file generated by the metadata-file generating unit 114 may be an MPD (media presentation description) file, a standard of which is defined by ISO/IEC 23009-1.

Furthermore, the metadata-file generating unit 114 according to the present embodiment may store the multi-view zoom-switch information in a metadata file. The metadata-file generating unit 114 according to the present embodiment may store the multi-view zoom-switch information in the metadata file, associating with each viewpoint included in plural switchable viewpoints (viewpoints of a multi-view content). A storage example of the multi-view zoom-switch information in the metadata file will be described later.

The metadata-file generating unit 114 outputs the generated MPD file to the communication unit 130.

The control unit 120 is a functional component that controls the entire processing performed by the generating device 100 in a centralized manner. For example, it is noted that what is controlled by the control unit 120 is not particularly limited. For example, the control unit 120 may control processing generally performed by a general-purpose computer, a PC, a tablet PC, and the like.

Moreover, when the generating device 100 is used at the time of content creation, the control unit 120 may perform processing related to generation of the position information of object audio data, and generation of the multi-view zoom-switch information explained with reference to FIG. 13, in accordance with a user operation made through an operating unit not illustrated.

The communication unit 130 performs various kinds of communications with the distribution server 200. For example, the communication unit 130 transmits an MP4 file and an MPD file generated by the generating device 100 to the distribution server 200. What is communicated by the communication unit 130 is not limited to these.

The storage unit 140 is a functional component that stores various kinds of information. For example, the storage unit 140 stores the multi-view zoom-switch information, a multi-view image signal, an audio object signal, an MP4 file, an MPD file, and the like, or stores a program or a parameter used by respective functional components of the generating device 100, and the like. What is stored by the storage unit 140 is not limited to these.

(Functional Configuration of Distribution Server)

FIG. 17 is a block diagram illustrating a functional configuration example of the distribution server 200 according to the present embodiment. As illustrated in FIG. 17, the distribution server 200 according to the present embodiment includes a control unit 220, a communication unit 230, and a storage unit 240.

The control unit 220 is a functional component that controls the entire processing performed by the distribution server 200 in a centralized manner, and performs a control related to streaming distribution by MPEG-DASH. For example, the control unit 220 causes various kinds of information stored in the storage unit 240 to be transmitted to the client 300 through the communication unit 230 based on request information from the client 300 received through the communication unit 230 or the like. What is controlled by the control unit 220 is not particularly limited. For example, the control unit 120 may control processing generally performed by a general-purpose computer, a PC, a tablet PC, and the like.

The communication unit 230 performs various kinds of communications with the distribution server 200 and the client 300. For example, the communication unit 230 receives an MP4 file and an MPD file from the distribution server 200. Moreover, the communication unit 230 transmits, to the client 300, an MP4 file or an MPD file according to request information received from the client 300 in accordance with a control of the control unit 220. What is communicated by the communication unit 230 is not limited to these.

The storage unit 240 is a functional component that stores various kinds of information. For example, the storage unit 240 stores an MP4 file, an MPD file, and the like received from the generating device 100, or stores a program or a parameter used by the respective functional components of the distribution server 200, and the like. What is stored by the storage unit 240 is not limited to these.

(Functional Configuration of Client)

FIG. 18 is a block diagram illustrating a functional configuration example of the client 300 according to the present embodiment. As illustrated in FIG. 18, the client 300 according to the present embodiment includes a processing unit 310, a control unit 340, a communication unit 350, and a storage unit 360.

The processing unit 310 is a functional component that performs processing related to reproduction of a content. The processing unit 310 may perform, for example, processing related to the viewpoint switch explained with reference to FIG. 14. As illustrated in FIG. 18, the processing unit 310 has functions as a metadata-file acquiring unit 311, a metadata-file processing unit 312, a segment-file-selection control unit 313, an image processing unit 320, and an audio processing unit 330.

The metadata-file acquiring unit 311 is a functional component that acquires an MPD file (metadata file) from the distribution server 200 prior to reproduction of a content. More specifically, the metadata-file acquiring unit 311 generates request information of the MPD file based on a user operation or the like, and transmits the request information to the distribution server 200 through the communication unit 350, thereby acquiring the MPD file from the distribution server 200. The metadata-file acquiring unit 311 provides the acquired MPD file to the metadata-file processing unit 312.

The metadata file acquired by the metadata-file acquiring unit 311 includes the multi-view zoom-switch information as described above.

The metadata-file processing unit 312 is a functional component that performs processing related to the MPD file provided from the metadata-file acquiring unit 311. More specifically, the metadata-file processing unit 312 recognizes information necessary for acquiring an MP4 file or the like (for example, URL or the like) based on an analysis of the MPD file. The metadata-file processing unit 312 provides these information to the segment-file-selection control unit 313.

The segment-file-selection control unit 313 is a functional component that selects a segment file (MP4 file) to be acquired. More specifically, the segment-file-selection control unit 313 selects a segment file to be acquired based on various information provided from the metadata-file processing unit 312 described above. For example, the segment-file-selection control unit 313 according to the present embodiment selects a segment file of a switch destination viewpoint when a viewpoint switch is caused by the viewpoint switch processing explained with reference to FIG. 14.

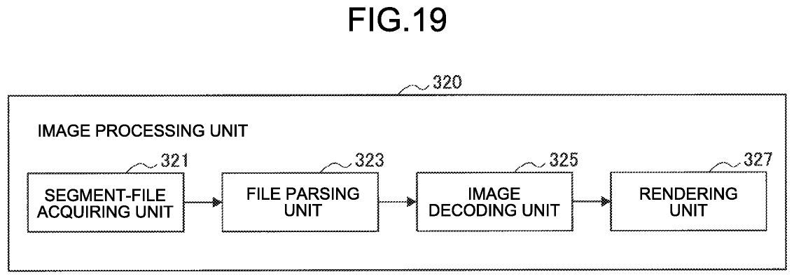

The image processing unit 320 acquires a segment file based on information selected by the segment-file-selection control unit 313, and performs image processing. FIG. 19 illustrates a functional configuration example of the image processing unit 320.

As illustrated in FIG. 19, the image processing unit 320 has functions as a segment-file acquiring unit 321, a file parsing unit 323, an image decoding unit 325, and a rendering unit 327. The segment-file acquiring unit 321 generates request information based on information selected by the segment-file-selection control unit 313 to transmit to the distribution server 200, and thereby acquires an appropriate segment file (MP4 file) from the distribution server 200, to provide to the file parsing unit 323. The file parsing unit 323 analyzes the acquired segment file, and divides it into system layer metadata and an image stream, to provide to the image decoding unit 325. The image decoding unit 325 performs decoding processing with respect to the system layer metadata and the image stream, and provides image position metadata and a decoded image signal to the rendering unit 327. The rendering unit 327 determines a cut-out range based on the information provided by the output device 400, and generates a display image by performing a cut-out of an image. The display image cut out by the rendering unit 327 is transmitted to the output device 300 through the communication unit 350, and is displayed on the output device 400.

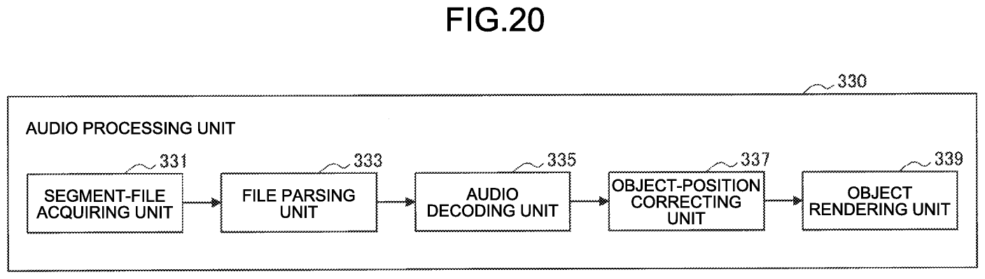

The audio processing unit 330 acquires a segment file based on the information selected by the segment-file-selection control unit 313, and performs audio processing. FIG. 20 illustrates a functional configuration example of the audio processing unit 330.

As illustrated in FIG. 20, the audio processing unit 330 has functions as a segment-file acquiring unit 331, a file parsing unit 333, an audio encoding unit 335, an object-position correcting unit 337, and an object rendering unit 339. The segment-file acquiring unit 331 generates request information based on information selected by the segment-file-selection control unit 313, to transmit to the distribution server 200, and thereby acquires an appropriate segment file (MP4 file) from the distribution server 200, to provide to the file parsing unit 333. The file parsing unit 333 analyzes the acquired segment file, and divides it to system layer metadata and an audio stream to provide to the audio decoding unit 335. The audio decoding unit 335 performs decoding processing with respect to the system layer metadata and the audio stream, and provides audio position metadata indicating a position of the audio object and a decoded audio signal to the object-position correcting unit 337. The object-position correcting unit 337 performs correction of a position of the audio object based on the object position metadata and the multi-view zoom-switch information described above, and provides the position information of the audio object after correction and the decoded audio signal to the audio rendering unit 329. The object rendering unit 339 performs rendering processing of plural audio objects based on the position information of the audio object after correction and the decoded audio object. The audio data synthesized by the object rendering unit 339 is transmitted to the output device 400 through the communication unit 350, to be audio output from the output device 400.

The control unit 340 is a functional configuration that controls the entire processing performed by the client 300 in a centralized manner. For example, the control unit 340 may control various kinds of processing based on an input performed by using an input unit (not illustrated), such as a mouse and a keyboard, by a user. What is controlled by the control unit 340 is not particularly limited. For example, the control unit 340 may control processing generally performed by a general-purpose computer, a PC, a tablet PC, and the like.

The communication unit 350 performs various kinds of communications with the distribution server 200. For example, the communication unit 350 transmits request information provided by the processing unit 310 to the distribution server 200. Moreover, the communication unit 350 functions as a receiving unit also, and receives an MPD file, an MP4 file, and the like as a response to the request information from the distribution server 200. What is communicated by the communication unit 350 is not limited to these.

The storage unit 360 is a functional component that stores various kinds of information. For example, the storage unit 360 stores the MPD file, the MP4 file, and the like acquired from the distribution server 200, or stores a program or a parameter used by the respective functional components of the client 300, and the like. Information stored by the storage unit 360 is not limited to these.

<3-2. Storage Example of Multi-View Zoom-Switch Information in Metadata File>

As above, a configuration example of the present embodiment has been explained. Subsequently, a storage example of the multi-view zoom-switch information in a metadata file generated by the metadata-file generating unit 114 in the present embodiment will be explained.

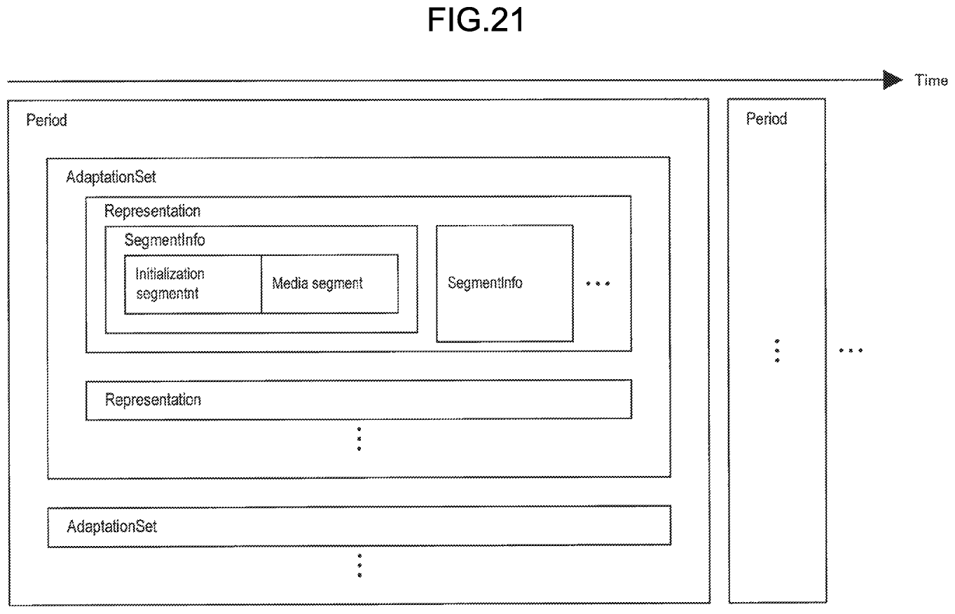

First, a layer structure of an MPD file will be explained. FIG. 21 is a diagram for explaining a layer structure of an MPD file that is defined by ISO/IEC 23009-1 standard. As illustrated in FIG. 21, the MPD file is constituted of at least one of Period. In Period, meta information of data, such as synchronized images and audio data, is stored. For example, in Period, plural pieces of AdaptationSet to group selection ranges (Representation group) of a stream are stored.

In Representation, information of an encoding speed of an image and an audio, an image size, and the like is stored. In Representation, plural pieces of Segmentlnfo are stored. Segmentlnfo includes information relating to a segment that is obtained by dividing a stream into plural files. In Segmentlnfo, Initialization segment that indicates initial information, such as a data compression method, and Media segment that indicates a segment of a moving image and a sound is included.

As above, a layer structure of an MPD file has been explained. The metadata-file generating unit 114 according to the present embodiment may store the multi-view zoom-switch information in the MPD file described above.

(Example of Storing AdaptationSet)

As described above, because the multi-view zoom-switch information is present per viewpoint, it is preferable to be stored in an MPD file associated with each viewpoint. In a multi-view content, each viewpoint can correspond to AdaptationSet. Therefore, the metadata-file generating unit 114 according to the present embodiment may store the multi-view zoom-switch information, for example, in AdaptationSet described above. In such a configuration, the client 300 can acquire the multi-view zoom-switch information at the time or reproduction.

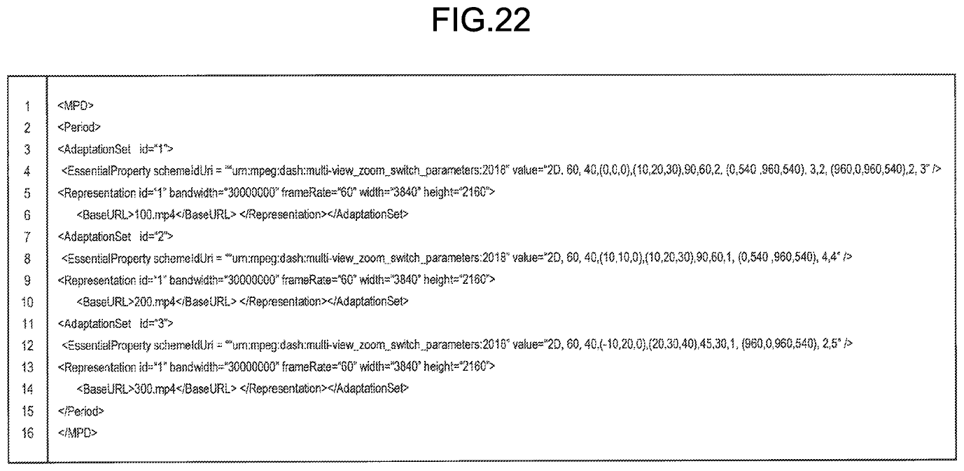

FIG. 22 is a diagram illustrating an example of the MPD file that is generated by the metadata-file generating unit 114 according to the present embodiment. FIG. 22 illustrates an example of an MPD file in a multi-view content constituted of three viewpoints. Moreover, in the MPD file illustrated in FIG. 22, element and attribute that are extraneous to characteristics of the present embodiment are omitted.

As indicated on the fourth line, the eight line, and the twelfth line in FIG. 22, EssentialProperty defined as expanded property of AdaptationSet is stored as the multi-view zoom-switch information in AdaptationSet. Instead of EssentialProperty, SupplementalProperty may be used, and in this case, by replacing EssentialProperty with SupplementalProperty, it can be similarly described.

Furthermore, as indicated on the fourth line, the eighth line, and the twelfth line in FIG. 22, schemeldUri of EssentialProperty is determined as a name indicating the multi-view zoom-switch information, and values of the multi-view zoom-switch information described above are aligned at values of EssentialProperty. In the example illustrated in FIG. 22, schemeldUri is “urn:mpeg:dash:multi-view_zoom_switch_parameters:2018”. Moreover, value expresses the multi-view zoom-switch information as “(image type information), (shooting-related information), (angle-of-view information at the time of content creation), (the number of switch-destination viewpoint information), (switch-destination viewpoint information 1), (switch-destination viewpoint information 2), . . . ”. A character string indicated at schemeldUri in FIG. 22 is one example, and is not limited to the example.

Moreover, the MPD file generated by the metadata-file generating unit 114 according to the present embodiment is not limited to the example illustrated in FIG. 22. For example, the metadata-file generating unit 114 according to the present embodiment may store the multi-view zoom-switch information in Period described above. In this case, because the multi-view zoom-switch information is associated with each viewpoint, the multi-view zoom-switch information may be stored in Period, associated with each AdaptationSet included relevant Period. According to such a configuration, the client 300 can acquire the multi-view zoom-switch information corresponding to a viewpoint at reproduction.

(Example of Storing in Period, Associating with AdaptationSet)

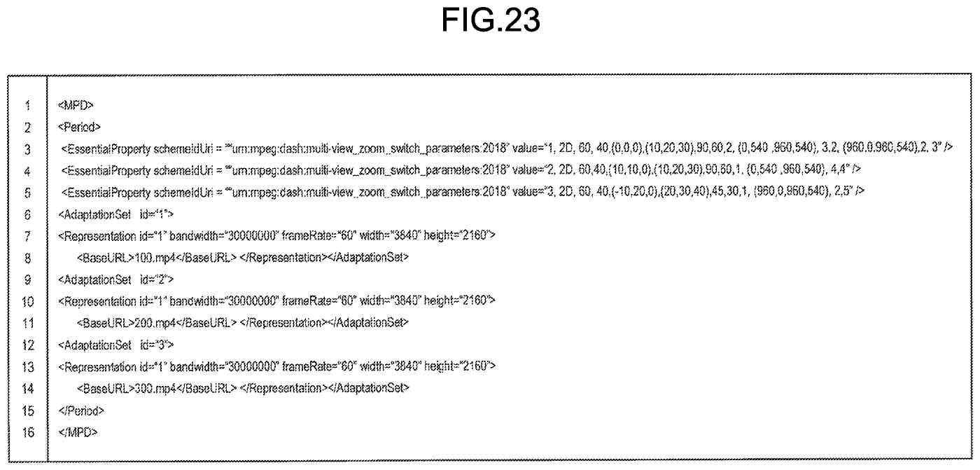

FIG. 23 illustrates another example of an MPD file that is generated by the metadata-file generating unit 114 according to the present embodiment. FIG. 23 illustrates an example of an MPD file in a multi-view content constituted of three viewpoints similarly to FIG. 22. Furthermore, in the MPD file illustrated in FIG. 23, element and attribute that are extraneous to characteristics of the present embodiment are omitted.

As indicated on the third to the fifth lines in FIG. 23, EssentialProperty defined as expanded property of Period is stored as many as the number of AdaptationSet together in Period as the multi-view zoom-switch information. Instead of EssentialProperty, SupplementalProperty may be used, and in this case, by replacing EssentialProperty with SupplementalProperty, it can be similarly described.

As for schemeldUri of EssentialProperty indicated in FIG. 23 is similar to schemeldUri explained with reference to FIG. 22 and, therefore, explanation thereof is omitted. In the example illustrated in FIG. 23, value of EssentialProperty includes the multi-view zoom-switch information described above, similarly to value explained with reference to FIG. 22. However, value indicated in FIG. 23 includes a value of AdaptationSet id at the top, in addition to value explained with reference to FIG. 22, and is associated with each AdaptationSet.

For example, in FIG. 23, the multi-view zoom-switch information on the third line is associated with AdaptationSet on the sixth to the eighth lines, the multi-view zoom-switch information on the fourth line is associated with AdaptationSet on the ninth to the eleventh lines, and the multi-view zoom-switch information is associated with AdaptationSet on the twelfth to the fourteenth lines.

(Modification)

As above, the storage example of the multi-view zoom-switch information in an MPD file by the metadata-file generating unit 114 according to the present embodiment has been explained, but the present embodiment is not limited to the example.

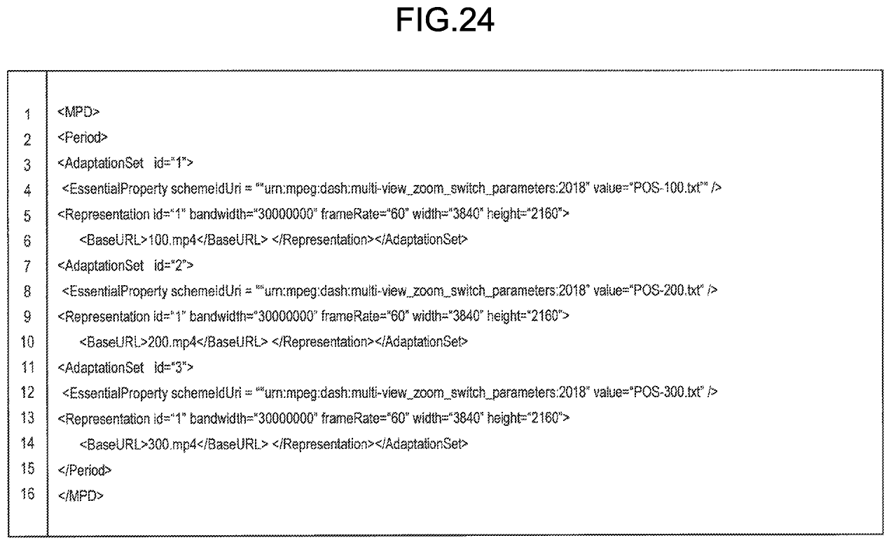

For example, as a modification, the metadata-file generating unit 114 may generate another metadata file different from the MPD file, in addition to the MPD file, and may store the multi-view zoom-switch information in this metadata file. Furthermore, the metadata-file generating unit 114 may store access information to access the metadata file in which the multi-view zoom-switch information is stored in the MPD file. The MPD file generated by the metadata-file generating unit 114 in this modification will be explained, referring to FIG. 24.

FIG. 24 is a diagram illustrating one example of the MPD file that is generated by the metadata-file generating unit 114 according to the present modification. FIG. 24 illustrates an example of an MPD file in a multi-view content constituted of three viewpoints similarly to FIG. 22. Moreover, in the MPD file illustrated in FIG. 24, element and attribute that are extraneous to characteristics of the present embodiment are omitted.

As indicated on the fourth line, the eight line, and the twelfth line in FIG. 24, EssentialProperty defined as expanded property of AdaptationSet is stored in AdaptationSet as access information. Instead of EssentialProperty, SupplementalProperty may be used, and in this case, by replacing EssentialProperty with SupplementalProperty, it can be similarly described.

As for schemeldUri of EssentialProperty indicated in FIG. 24, it is similar to schemeldUri explained with reference to FIG. 22 and, therefore, explanation thereof is omitted. In the example illustrated in FIG. 24, value of EssentialProperty includes the access information to access the metadata file in which the multi-view zoom-switch information is stored.

For example, POS-100.txt indicated in value on the fourth line in FIG. 24 includes the multi-view zoom-switch information, and may be a metadata file having contents as follows.

### 2D, 60, 40, (0, 0, 0), (10, 20, 30), 90, 60, 2, (0, 540, 960, 540), 3, 2, (960, 0, 960, 540), 2, 3

Moreover, POS-200.txt indicated in value on the eighth line in FIG. 24 includes the multi-view zoom-switch information, and may be a metadata file having contents as follows.

### 2D, 60, 40, (10, 10, 0), (10, 20, 30), 90, 60, 1, (0, 540, 960, 540), 4, 4

Moreover, POS-300.txt indicated in value on the twelfth line in FIG. 24 includes the multi-view zoom-switch information, and may be a metadata file having contents as follows.

### 2D, 60, 40, (−10, 20, 0), (20, 30, 40), 45, 30, 1, (960, 0, 960, 540), 2, 5

While the example in which the access information is stored in AdaptationSet has been explained in FIG. 24, similarly to the example explained with reference to FIG. 23, the access information may be stored in Period, associated with each AdaptationSet.

<3-3. Operation Example>

As above, the metadata file generated by the metadata-file generating unit 114 in the present embodiment has been explained. Subsequently, an operation example according to the present embodiment will be explained.

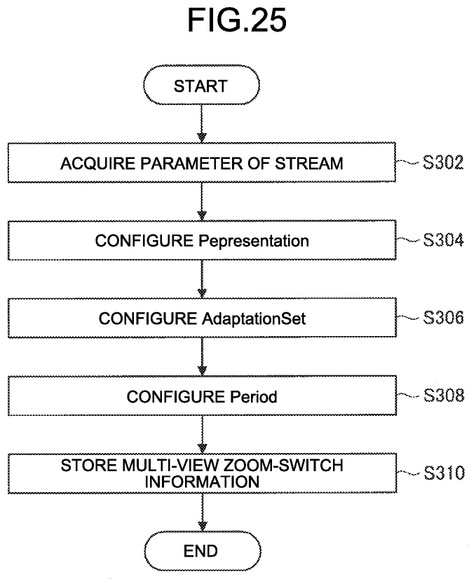

FIG. 25 is a flowchart illustrating one example of an operation of the generating device 100 according to the embodiment. In FIG. 25, an operation relating to generation of a metadata file by the metadata-file generating unit 114 of the generating device 100 is mainly illustrated, and the generating device 100 may perform an operation not illustrated in FIG. 25, of course.

As illustrated in FIG. 25, the metadata-file generating unit 114 first acquires a parameter of an image stream and an audio stream (S302). Subsequently, the metadata-file generating unit 114 configures Pepresentation based on the parameter of the image stream and the audio stream (S304). Subsequently, the metadata-file generating unit 114 configures Period (S308). The metadata-file generating unit 114 then stores the multi-view zoom-switch information as described above, and generates an MPD file (S310).

Processing related to generation of the multi-view zoom-switch information explained with reference to FIG. 13 may be performed prior to processing illustrated in FIG. 25, or at least prior to step S310, to generate the multi-view zoom-switch information.

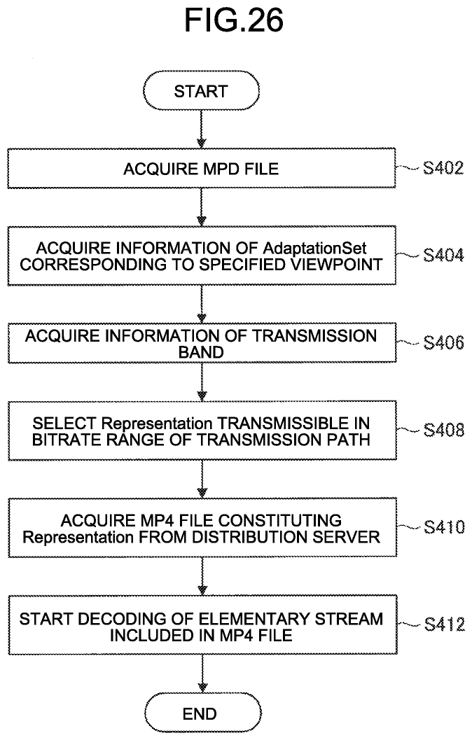

FIG. 26 is a flowchart illustrating one example of an operation of the client 300 according to the embodiment. The client 300 may perform an operation not illustrated in FIG. 26, of course.

As illustrated in FIG. 26, first, the processing unit 310 acquires an MPD file (S402). Subsequently, the processing unit 310 acquires information of AdaptationSet corresponding to a specified viewpoint (S404). The specified viewpoint may be, for example, a viewpoint of an initial setting, may be a viewpoint selected by a user, or may be a switch destination viewpoint identified by the viewpoint switch processing explained with reference to FIG. 14.

Subsequently, the processing unit 310 acquires information of a transmission band (S406), and selects Representation that can be transmitted in a bitrate range of a transmission path (S408). Furthermore, the processing unit 310 acquires an MP4 file constituting Representation selected at step S408 from the distribution server 200 (S410). The processing unit 310 then starts decoding of an elementary streaming included in the MP4 file acquired at step S410 (S412).

### 4. SECOND EMBODIMENT

As above, the first embodiment has been explained. While an example in which streaming distribution is performed by MPEG-DASH has been explained in the first embodiment described above, hereinafter, an example in which a content file is provided through a storage device instead of streaming distribution will be explained as a second embodiment. Moreover, in the present embodiment, the multi-view zoom-switch information described above is stored in a content file.

<4-1. Configuration Example>

Functional Configuration Example of Generating Device

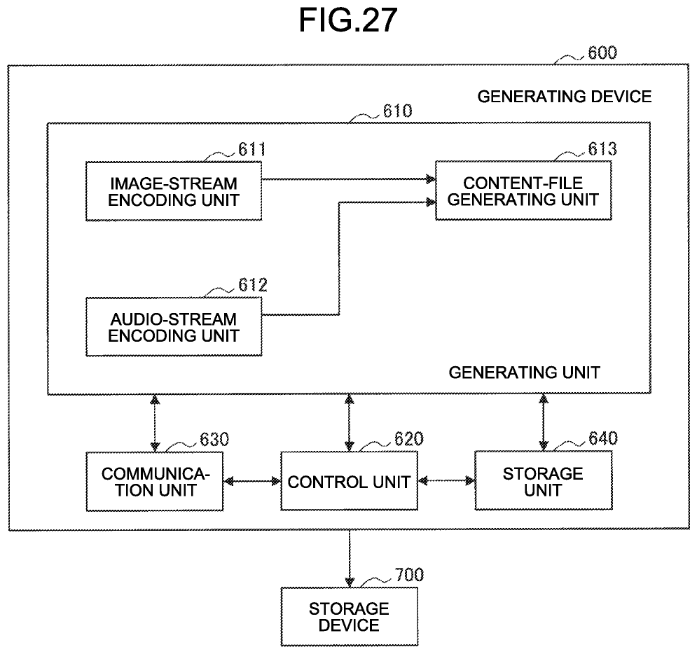

FIG. 27 is a block diagram illustrating a functional configuration example of a generating device 600 according to the second embodiment of the present disclosure. The generating device 600 according to the present embodiment is an information processing device that generates a content file. Moreover, the generating device 600 can be connected to a storage device 700. The storage device 700 stores the content file generated by the generating device 600. The storage device 700 may be, for example, a portable storage.

As illustrated in FIG. 27, the generating device 600 according to the present embodiment includes a generating unit 610, a control unit 620, a communication unit 630, and a storage unit 640.

The generating unit 610 performs processing related to an image and an audio, and generates a content file. As illustrated in FIG. 27, the generating unit 610 has functions as an image-stream encoding unit 611, an audio-stream encoding unit 612, and a content-file generating unit 613. Functions of the image-stream encoding unit 611 and the audio-stream encoding unit 612 may be similar to the functions of the image-stream encoding unit 111 and the audio-stream encoding unit 112.

The content-file generating unit 613 generates a content file based on information provided from the image-stream encoding unit 611 and the audio-stream encoding unit 612. A content file generated by the content-file generating unit 613 according to the present embodiment may be an MP4 file (ISOBMFF file) similarly to the first embodiment described above.

However, the content-file generating unit 613 according to the present embodiment stores the multi-view zoom-switch information in a header of the content file. Moreover, the content-file generating unit 613 according to the present embodiment may store the multi-view zoom-switch information in the header, associating the multi-view zoom-switch information with each viewpoint included in plural switchable viewpoints (viewpoints of a multi-view content). A storage example of the multi-view zoom-switch information in a header of a content file will be described later.

The MP4 file generated by the content-file generating unit 613 is output and stored in the storage device 700 illustrated in FIG. 27.

The control unit 620 is a functional component that controls the entire processing performed by the generating device 600 in a centralized manner. For example, it is noted that what is controlled by the control unit 620 is not limited. For example, the control unit 620 may control processing generally performed by a general-purpose computer, a PC, a tablet PC, and the like.

The communication unit 630 performs various kinds of communications. For example, the communication unit 630 transmits an MP4 file generated by the generating unit 110 to the storage device 700. What is communicated by the communication unit 630 is not limited to these.

The storage unit 640 is a functional component that stores various kinds of information. For example, the storage unit 640 stores the multi-view zoom-switch information, a multi-view image signal, an audio object signal, an MP4 file, and the like, or stores a program or a parameter used by the respective functional components of the generating unit 600, and the like. What is stored by the storage unit 640 is not limited to these.

(Functional Configuration Example of Reproducing Device)

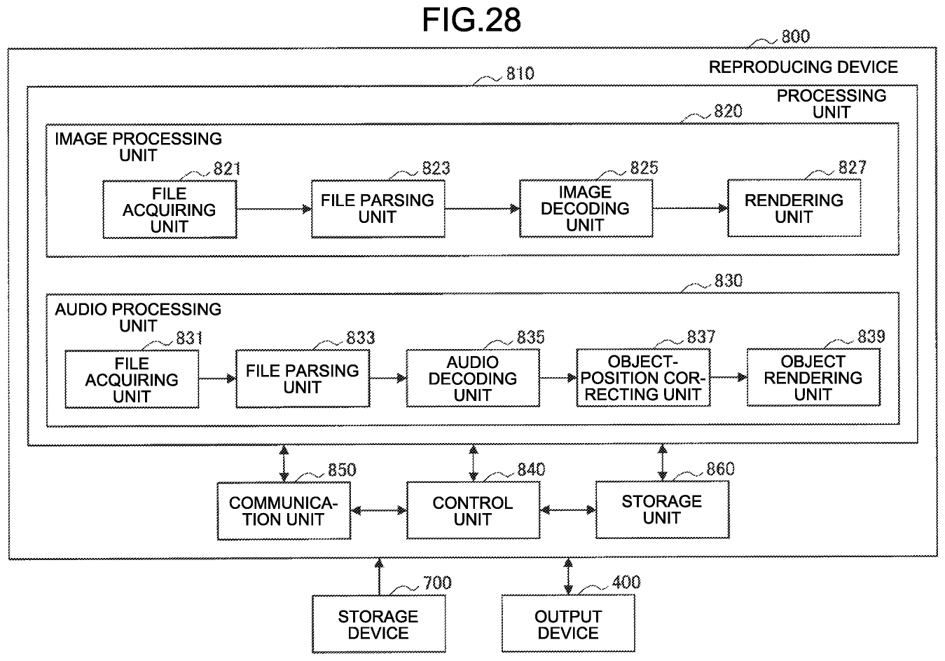

FIG. 28 is a block diagram illustrating a functional configuration example of a reproducing device 800 according to the present embodiment. The reproducing device 800 according to the present embodiment is connected to the storage device 700, and is an information processing device that acquires an MP4 file stored in the storage device 700 to reproduce it. The reproducing device 800 is connected to the output device 400, and causes the output device 400 to display a display image, and to output an audio. The reproducing device 800 may be connected to the output device 400 of a ground-mounted type or the output device 400 mounted on a user similarly to the client 300 illustrated in FIG. 15, or may be integrated with the output device 400.

Moreover, as illustrated in FIG. 28, the reproducing device 800 according to the present embodiment includes a processing unit 810, a control unit 840, a communication unit 850, and a storage unit 860.

The processing unit 810 is a functional component that performs processing related to reproduction of a content. The processing unit 810 may perform, for example, processing related to the viewpoint switch explained with reference to FIG. 14. As illustrated in FIG. 28, the processing unit 810 has functions of the image processing unit 820 and the audio processing unit 830.

The image processing unit 820 acquires an MP4 file stored in the storage device 700, and performs image processing. As illustrated in FIG. 28, the image processing unit 820 has functions as a file acquiring unit 821, a file parsing unit 823, an image decoding unit 825, and a rendering unit 827. The file acquiring unit 821 functions as a content-file acquiring unit, and acquires an MP4 file from the storage device 700 to provide to the file parsing unit 823. The MP4 file acquired by the file acquiring unit 821 includes the multi-view zoom-switch information as described above, and the multi-view zoom-switch information is stored in a header. The file parsing unit 823 analyzes the acquired MP4 file, and divides it into system layer metadata (header) and an image stream, to provide to the image decoding unit 825. Functions of the image decoding unit 825 and the rendering unit 827 are similar to the functions of the image decoding unit 325 and the rendering unit 327 explained with reference to FIG. 19 and, therefore, explanation thereof is omitted.

The audio processing unit 830 acquires an MP4 file stored in the storage device 700, and performs audio processing. As illustrated in FIG. 28, the audio processing unit 830 has functions as a file acquiring unit 831, an audio decoding unit 835, an object-position correcting unit 837, and an object rendering unit 839. The file acquiring unit 831 functions as a content-file acquiring unit, and acquires an MP4 file from the storage device 700 to provide to the file parsing unit 833. The MP4 file acquired by the file acquiring unit 831 includes the multi-view zoom-switch information as described above, and the multi-view zoom-switch information is stored in a header. The file parsing unit 833 analyzes the acquired MP4 file, and divides it into system layer metadata (header) and an image stream, to provide to the audio decoding unit 835. Functions of the audio decoding unit 835, the object-position correcting unit 837, and the object rendering unit 839 are similar to the functions of the audio decoding unit 335, the object-position correcting unit 837, and the object rendering unit 339 explained with reference to FIG. 20 and, therefore, explanation thereof is omitted.

The control unit 840 is a functional component that controls the entire processing performed by the reproducing device 800 in a centralized manner. For example, the control unit 840 may control various kinds of processing based in an input made by using an input unit (not illustrated), such as a mouse and a keyboard, by a user. What is controlled by the control unit 840 is not particularly limited. For example, the control unit 340 may control processing generally performed by a general-purpose computer, a PC, a tablet PC, and the like.

The communication unit 850 performs various kinds of communications. Moreover, the communication unit 850 also functions as a receiving unit, and receives an MP4 file and the like from the storage device 700. What is communicated by the communication unit 850 is not limited to these.

The storage unit 860 is a functional component that stores various kinds of information. For example, the storage unit 860 stores an MP4 file and the like acquired from the storage device 700, or stores a program or a parameter used by the respective functional components of the reproducing device 800, and the like. What is stored by the storage unit 860 is not limited to these.

As above, the generating device 600 and the reproducing device 800 according to the present embodiment have been explained. Although an example in which an MP4 file is provided through the storage device 700 has been explained above, it is not limited to the example. For example, the generating device 600 and the reproducing device 800 may be connected to each other directly or through a communication network, and an MP4 file may be transmitted from the generating device 600 to the reproducing device 800, to be stored in the storage unit 860 of the reproducing device 800.

<4-2. Storage Example of Multi-View Zoom-Switch Information in Content File>

As above, the configuration example of the present embodiment has been explained. Subsequently, a storage example of the multi-view zoom-switch information in a header of a content file generated by the content-file generating unit 613 will be explained in the present embodiment.

As described above, the content file generated by the content-file generating unit 613 in the present embodiment may be an MP4 file. When the MP4 file is an ISOBMFF file, standard of which is defined by ISO/IEC 14496-12, a moov box (system layer metadata) is included in the MP4 file as a header of the MP4 file.

(Storage Example of Storing in Udta Box)

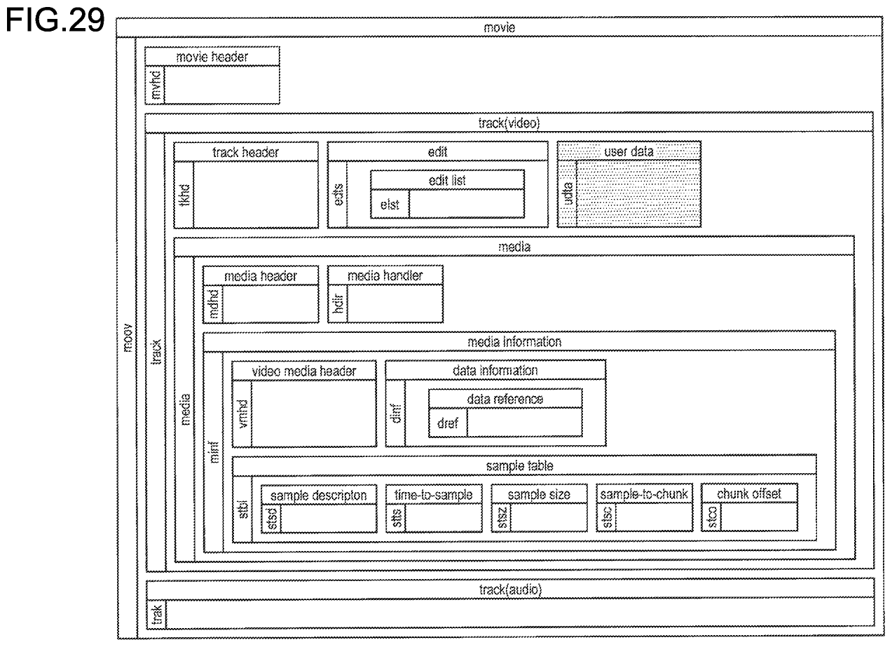

FIG. 29 is a diagram illustrating a box structure of a moov box in an ISOBMFF file. The content-file generating unit 613 according to the present embodiment may store the multi-view zoom-switch information, for example, in a udta box out of moov boxes illustrated in FIG. 29. The udta box can store arbitrary user data, and is included in a track box as illustrated in FIG. 29, to be static metadata with respect to video track. A region in which the multi-view zoom-switch information is stored is not limited to the udta box at a hierarchical position illustrated in FIG. 29. For example, it is possible to provide an expanded region inside by changing a version of an existing box (the expanded region is also defined, for example, as one box), and to store the multi-view zoom-switch information in the expanded region.

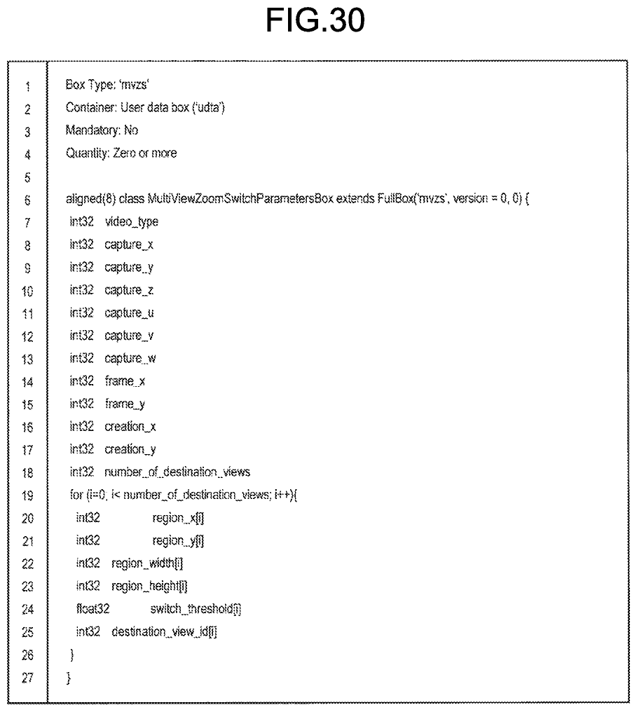

FIG. 30 is a diagram illustrating an example of the udta box when the multi-view zoom-switch information is stored in the udta box. video_type on the seventh line in FIG. 30 corresponds to the image type information illustrated in FIG. 9. Moreover, parameters on the eight line to the fifteenth line in FIG. 30 correspond to the shooting-related information illustrated in FIG. 9. Furthermore, parameters on the sixteenth line to the seventeenth line in FIG. 30 correspond to the angle-of-view information at the time of content creation illustrated in FIG. 9. Moreover, number of destination views on the eighteenth line in FIG. 30 corresponds to the number of the switch-destination viewpoint information illustrated in FIG. 9. Furthermore, parameters on the twentieth line to the twenty-fifth line in FIG. 30 corresponds to the switch-destination viewpoint information illustrated in FIG. 9, and are stored for each viewpoint, associated with a viewpoint.

(Example of Storing as Metadata Track)

Although an example in which the multi-view zoom-switch information is stored in a udta box as static metadata with respect to video track has been explained above, the present embodiment is not limited thereto. For example, when the multi-view zoom-switch information changes according to a reproduction time, it is difficult to store in a udta box.

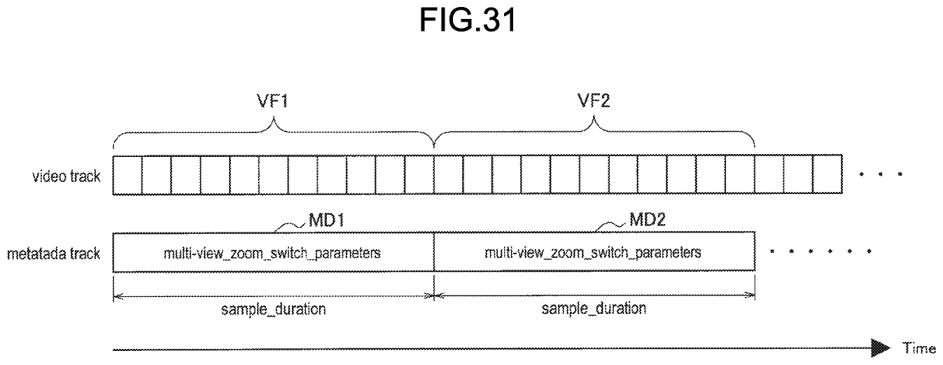

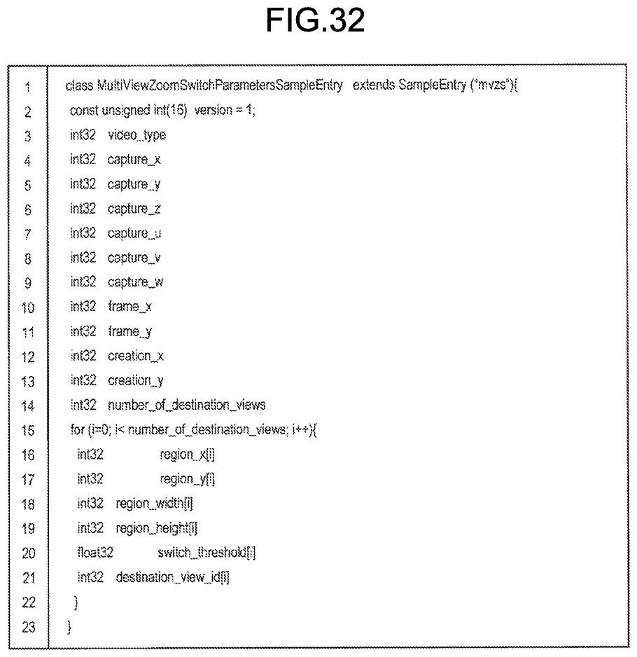

Therefore, when the multi-view zoom-switch information changes according to a reproduction time, by using track, which has a structure having a time axis, new metadata track that indicates the multi-view zoom-switch information may be defined. A definition method of metadata track in ISOBMFF is described in ISO/IEC 14496-12, and metadata track according to the present example may be defined conforming to ISO/IEC 14496-12. This example will be explained, referring to FIG. 31 to FIG. 32.

In the present example, the content-file generating unit 613 stores the multi-view zoom-switch information in a mdat box as timed metadata track. In the present example, the content-file generating unit 613 can store the multi-view zoom-switch information also in a moon box.

FIG. 31 is an explanatory diagram for explaining metadata track. In the example illustrated in FIG. 31, a time range in which the multi-view zoom-switch information does not change is defined as one sample, and one sample is associated with one multi-view_zoom_switch_parameters (the multi-view zoom-switch information). Time in which one multi-view_zoom_switch_parameters is effective can be expressed by sample duration. As for other information relating to sample, such as a size of sample, information inf stbl box illustrated in FIG. 29 may be used as it is.

For example, in the example illustrated in FIG. 31, multi-view_zoom_switch_parameters MD1 is stored in a mdat box as the multi-view_zoom_switch_parameters applied to a video frame of a range VF1. Moreover, multi-view_zoom_switch_parameters MD2 is stored in a mdat box as the multi-view zoom-switch information applied to a video frame of a range VF2 illustrated in FIG. 32.

Furthermore, in the present example, the content-file generating unit 613 can store the multi-view zoom-switch information also in a moov box. FIG. 32 is a diagram for explaining the multi-view zoom-switch information stored in a moov box by a content-file generating unit 613 in the present example.

In the present example, the content-file generating unit 613 may define sample as illustrated in FIG. 32, and may store in a moov box. Respective parameters illustrated in FIG. 32 are similar to the parameters indicating the multi-view zoom-switch information explained, referring to FIG. 30.

<4-3. Operation Example>

As above, a content file generated by the content-file generating unit 613 has been explained in the present embodiment. Subsequently, an operation example according to the present embodiment will be explained.

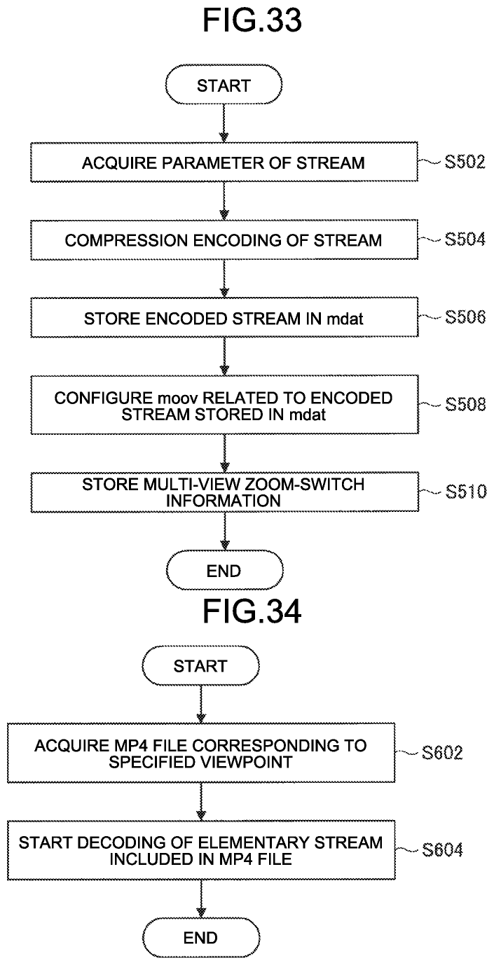

FIG. 33 is a flowchart illustrating an example of an operation of the generating device 600 according to the present embodiment. FIG. 33 mainly illustrates an operation relating to generation of an MP4 file by the generating unit 610 of the generating device 600, and the generating device 600 may perform an operation not illustrated in FIG. 33, of course.

As illustrated in FIG. 33, the generating unit 610 first acquires a parameter of an image stream and an audio stream (S502). Subsequently, the generating unit 610 performs compression encoding of the image stream and the audio stream (S504). Subsequently, the content-file generating unit 613 stores an encoded stream acquired at step S504 in a mdat box (S506). The content-file generating unit 613 configures a moov box related to the encoded stream stored in the mdat box (S508). The content-file generating unit 613 then generates an MP4 file by storing the multi-view zoom-switch information in a moov box or in a mdat box as described above (S510).

Prior to the processing illustrated in FIG. 33, or at least before step S510, processing relating to generation of the multi-view zoom-switch information explained with reference to FIG. 13 may be performed to generate the multi-view zoom-switch information.

FIG. 34 is a flowchart illustrating one example of an operation of the reproducing device 800 according to the present embodiment. The reproducing device 800 may perform an operation not illustrated in FIG. 34, of course.

As illustrated in FIG. 34, first, the processing unit 810 acquires an MP4 file corresponding to a specified viewpoint (S602). The specified viewpoint may be, for example, a viewpoint of an initial setting, or may be a switch destination viewpoint identified by the viewpoint switch processing explained with reference to FIG. 14.

The processing unit 810 then starts decoding of an elementary stream included in the MP4 file acquired at step S602.

### 5. HARDWARE CONFIGURATION EXAMPLE

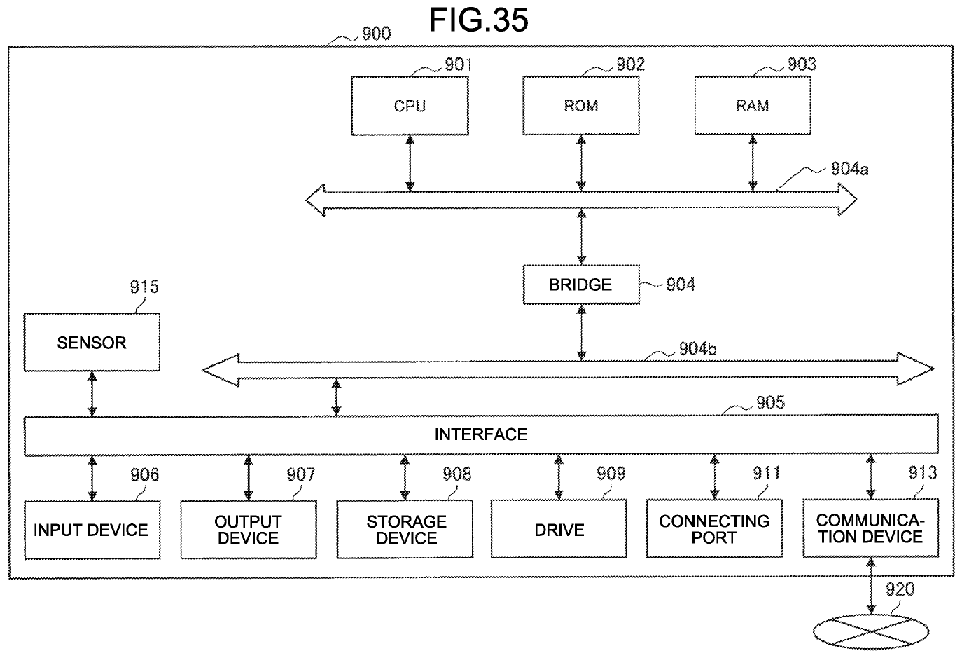

As above, embodiments of the present disclosure have been explained. Finally, a hardware configuration of the information processing device according to embodiments of the present disclosure will be explained, referring to FIG. 35. FIG. 35 is a block diagram illustrating one example of the hardware configuration of the information processing device according to embodiments of the present disclosure. An information processing device 900 illustrated in FIG. 35 can implement, for example, the generating device 100, the distribution server 200, the client 300, the generating device 600, the reproducing device 800 illustrated in FIGS. 15 to 18, FIG. 26, and FIG. 27. The information processing by the generating device 100, the distribution server 200, the client 300, the generating device 600, and the reproducing device 800 according to the embodiments of the present disclosure is implemented by cooperation of software and hardware explained below.

As illustrated in FIG. 35, the information processing device 900 includes a central processing unit (CPU) 901, a read only memory (ROM) 902, a random access memory (RAM) 903, and a host bus 904a. Furthermore, the information processing device 900 includes a bridge 904, an external bus 904b, an interface 905, an input device 906, an output device 907, a storage device 908, a drive 909, a connecting port 911, a communication device 913, and a sensor 915. The information processing device 900 may include a processing circuit, such as a DSP and an ASIC, in place of, or in addition to the CPU 901.

The CPU 901 functions as an arithmetic processing device and a control device, and controls overall operation in the information processing device 900 in accordance with various kinds of programs. Moreover, the CPU 901 may be a microprocessor. The ROM 902 stores a program, arithmetic parameters, and the like used by the CPU 901. The RAM 903 temporarily stores a program used at execution of the CPU 901, a parameter that appropriately varies at its execution, and the like. The CPU 901 can form, for example, the generating device 110, the control unit 120, the control unit 220, the processing unit 310, the control unit 340, the generating unit 610, the control unit 620, the processing unit 810, and the control unit 840.

The CPU 901, the ROM 902, and the RAM 903 are connected to one another through the host bus 904a including a CPU bus, or the like. The host bus 904a is connected to the external bus 904b, such as a peripheral component interconnect/interface (PCI) bus, through the bridge 904. The host bus 904a, the bridge 904, and the external bus 904b do not necessarily need to be formed separately, and functions of these components may be implemented in a single bus.

The input device 906 is implemented by a device to which information is input by a user, such as a mouse, a keyboard, a touch panel, a button, a microphone, a switch, and a lever, for example. Moreover, the input device 906 may be a remote control device that uses, for example, an infrared ray or other radio waves, or may be an externally connected device, such as a mobile phone and a PDA supporting operation of the information processing device 900. Furthermore, the input device 906 may include an input control circuit that generates an input signal based on information input by a user using the input means described above, and that outputs it to the CPU 901, and the like. A user of the information processing device 900 is enabled to input various kinds of data or to instruct a processing action with respect to the information processing device 900 by operating this input device 906.

The output device 907 is formed with a device that capable of notifying of acquired information to a user visually or aurally. These devices include a display device, such as a CRT display device, a liquid crystal display device, a plasma display device, an EL display device, and a lamp, a sound output device, such as a speaker and a headphone, a printer device, and the like. The output device 907 outputs a result obtained by various kinds of processing performed by the information processing device 900. Specifically, the display device visually displays a result obtained by various kinds of processing performed by the information processing device 900 in various forms, such as text, image, table, and graph. On the other hand, the sound output device converts an audio signal composed of reproduced sound data, acoustic data, or the like into an analog signal to aurally output.

The storage device 908 is a device for data storage formed as one example of a storage unit of the information processing device 900. The storage device 908 is implemented by, for example, a magnetic storage device, such as an HDD, a semiconductor storage device, an optical storage device, a magneto-optical storage device, or the like. The storage device 908 may include a recording medium, a recording device that records data on a recording medium, a reader device that reads data from a recording medium, a deletion device that deletes data recorded on a recording medium, and the like. This storage device 908 stores a program executed by the CPU 901, various kinds of data, various kinds of data acquired externally, and the like. The storage device 908 described above can form, for example, the storage unit 140, the storage unit 240, the storage unit 360, the storage unit 640, and the storage unit 860.

The drive 909 is a reader/writer for a recording medium, and is mounted in the information processing device 900, or is externally arranged. The drive 909 reads information recorded on an inserted removable recording medium, such as a magnetic disk, an optical disk, a magneto-optical disk, or a semiconductor memory, to output to the RAM 903. Moreover, the drive 909 can write information to a removable recording medium also.

The connecting port 911 is a interface connected to an external device, and is a connecting port to an external device to which data can be transmitted through, for example, a universal serial bus (USB), or the like.

The communication device 913 is a communication interface that is formed with a communication device or the like to connect to the network 920. The communication device 913 is a communication card for a wired or wireless local area network (LAN), a long term evolution (LTE), Bluetooth (registered trademark), or wireless USB (WUSB), or the like. Furthermore, the communication device 913 may be a router for optical communication, a router for asymmetric digital subscriber line (ADSL), a modem for various kinds of communications, or the like. This communication device 913 can communicate a signal and the like with the Internet or other communication devices, according to a predetermined protocol, such as TCP/IP. The communication device 913 can form, for example, the communication unit 130, the communication unit 230, the communication unit 350, the communication unit 630, and the communication unit 850.

The sensor 915 is various kinds of sensor, such as a acceleration sensor, a gyro sensor, a geomagnetic sensor, an optical sensor, a sound sensor, a range sensor, and a force sensor. The sensor 915 acquires information relating to the information processing device 900 itself, such as a posture and a moving speed of the information processing device 900, and information relating to a peripheral environment of the information processing device 900, such as brightness and noise of periphery of the information processing device 900. Furthermore, the sensor 915 may include a GPS sensor that measures a latitude and longitude, and altitude of the device by receiving a GPS signal.

The network 920 is a wired or wireless transmission path of information transmitted from a device connected to the network 920. For example, the network 920 may include a public circuit network, such as the Internet, a telephone line network, a satellite communication network, various kinds of local area networks (LAN) including Ethernet (registered trademark), a wide area network (WAN), and the like. Moreover, the network 920 may include a dedicated line network, such as Internet protocol-virtual private network (IP-VPN).

As above, one example of the hardware configuration that enables to implement functions of the information processing device 900 according to the embodiments of the present disclosure have been described. The respective components described above may be implemented by using a general-purpose members, or may be implemented by hardware specified to functions of the respective components. Therefore, according to a technical level of each time the embodiments of the present disclosure are performed, the hardware configuration to be applied can be changed as appropriate.

A computer program to implement the respective functions of the information processing device 900 according to the embodiments of the present disclosure as described above can be created, and install in a PC, or the like. Moreover, a computer-readable recording medium in which such a computer program is stored can also be provided. The recording medium is, for example, a magnetic disk, an optical disk, a magneto-optical disk, a flash memory, and the like. Furthermore, the computer program described above may be distributed, for example, through a network, without using a recording medium.

### 6. CONCLUSION

As explained above, according to the respective embodiments of the present disclosure, by using the multi-view zoom viewpoint switching information (viewpoint switch information) to perform viewpoint switch among plural viewpoints for reproduction of a content, a sense of awkwardness given to a user can be reduced visually and aurally. For example, as described above, it is possible to display a display image, matching a direction and a size of a subject between before and after a viewpoint switch based on the multi-view zoom viewpoint switching information. Furthermore, as described above, it is possible to reduce a sense of awkwardness given to a user by performing a position correction of an audio object in a viewpoint switch based on the multi-view zoom viewpoint switching information.

As above, exemplary embodiments of the present disclosure have been explained in detail with reference to the accompanying drawings, but a technical scope of the present disclosure is not limited to those examples. It is obvious that those having ordinary knowledge in the technical field of the present disclosure can think of various kinds of alteration examples and modification examples within a category of technical ideas described in claims, and those are also understood to belong to the technical range of the present disclosure naturally.

For example, in the first embodiment, an example in which the multi-view zoom-switch information is stored in a metadata file has been explained, but the present technique is not limited to the example. For example, as the first embodiment described above, even when streaming distribution is performed by MPEG-DASH, the multi-view zoom-switch information may be stored in a header of an MP4 file as explained in the second embodiment in place of or in addition to an MPD file. Particularly, when the multi-view zoom-switch information varies according to a reproduction time, it is difficult to store the multi-view zoom-switch information in an MPD file. Therefore, even when streaming distribution is performed by MPEG-DASH, the multi-view zoom-switch information may be stored in a mdat box as timed metadata track as the example explained with reference to FIG. 31 to FIG. 32. According to such a configuration, even when streaming distribution is performed by MPEG-DASH, and the multi-view zoom-switch information varies according to a reproduction time, the multi-view zoom-switch information can be provided to a device that reproduces a content.

Whether the multi-view zoom-switch information varies according to a reproduction time can be determined by, for example, a content creator. Accordingly, where to store the multi-view zoom-switch information may be determined by an operation of a content creator, or based on information given by the content creator.

Moreover, effects described in the present specification are only examples, and are not limited. That is, the technique according to the present disclosure can produce other effects apparent to those skilled in the art from description of the present specification, together with the effects described above, or instead of the effects described above.

Configurations as below also belong to the technical scope of the present disclosure.

(1)

An information processing device comprising

a metadata-file generating unit that generates a metadata file including viewpoint switch information to perform a position correction of an audio object at a viewpoint switch among a plurality of viewpoints.

(2)

The information processing device according to (1), wherein

the metadata file is a media presentation description (MPD) file.

(3)

The information processing device according to (2), wherein

the viewpoint switch information is stored in AdaptationSet in the MPD file.

(4)

The information processing device according to (2), wherein

the viewpoint switch information is stored in Period in the MPD file, associated with AdaptationSet in the MPD file.

(5)

The information processing device according to (1), wherein

the metadata-file generating unit further generates a media presentation description (MPD) file including access information to access the metadata file.

(6)

The information processing device according to (5), wherein

the access information is stored in AdaptationSet in the MPD file.

(7)

The information processing device according to (5), wherein

the access information is stored in Period in the MPD file, associated with AdaptationSet in the MPD file.

(8)

The information processing device according to any one of (1) to (7), wherein

the viewpoint switch information is stored in the metadata file, associated with each viewpoint included in the plurality of viewpoints.

(9)

The information processing device according to (8), wherein

the viewpoint switch information includes switch-destination viewpoint information related to a switch destination viewpoint switchable from a viewpoint associated with the viewpoint switch information.

(10)

The information processing device according to (9), wherein

the viewpoint switch information includes threshold information relating to a threshold for a switch to the switch destination viewpoint from a viewpoint associated with the viewpoint switch information.

(11)

The information processing device according to any one of (8) to (10), wherein

the viewpoint switch information includes shooting-related information of an image relevant to a viewpoint associated with the viewpoint switch information.

(12)

The information processing device according to (11), wherein

the shooting-related information includes shooting position information relating to a position of a camera that has taken the image.

(13)

The information processing device according to (11) or (12), wherein

the shooting-related information includes shooting direction information relating to a direction of a camera that has taken the image.

(14)

The information processing device according to any one of (11) to (13), wherein

the shooting-related information includes shooting angle-of-view information relating to an angle of view of a camera that has taken the image.

(15)

The information processing device according to any one of (8) to (14), wherein

the viewpoint switch information includes reference angle-of-view information relating to an angle of view of a screen referred to when position information of an audio object relevant to a viewpoint that is associated with the viewpoint switch information has been determined.

(16)

An information processing method that is performed by an information processing device, the method comprising

generating a metadata file that includes viewpoint switch information to perform a position correction of an audio object at a viewpoint switch among a plurality of viewpoints.

(17)

A program that causes a computer to implement a function of

generating a metadata that includes viewpoint switch information to perform a position correction of an audio object at a viewpoint switch among a plurality of viewpoints.

(18)

An image processing device that includes a metadata-file acquiring unit that acquires a metadata file including viewpoint switch information to perform a position correction of an audio object at a viewpoint switch among plural viewpoints.

(19) The information processing device according to (18) described above in which the metadata file is a media presentation description (MPD) file.
(20)

The information processing device according to (19) described above in which the viewpoint switch information is stored in AdaptationSet in the MPD file.

(21)

The information processing device according to (19) described above in which the viewpoint switch information is stored in Period in the MPD file, associated with AdaptationSet in the MPD file.

(22)

The information processing device according to (18) described above in which the metadata-file acquiring unit further acquires a media presentation description (MPD) file including access information to access the metadata file.

(23)

The information processing device according to (22) described above in which the access information is stored in AdaptationSet in the MPD file.

(24)

The information processing device according to (22) described above in which the access information is stored in Period in the MPD file, associated with AdaptationSet in the MPD file.

(25)

The information processing device according to (18) to (24)

described above in which the viewpoint switch information is stored in the metadata file, associated with each viewpoint included in the plural viewpoints.

(26)

The information processing device according to (25) described above in which the viewpoint switch information includes switch-destination viewpoint information relating to a switch destination viewpoint switchable from a viewpoint associated with the viewpoint switch information.

(27)

The information processing device according to (26) described above in which the switch destination information includes threshold information relating to a threshold for a switch to the switch destination viewpoint from a viewpoint associated with the viewpoint switch information.

(28)

The information processing device according to any one of (25) to (27) described above in which the viewpoint switch information includes shooting-related information of an image relevant to a viewpoint associated with the viewpoint switch information.

(29)

The information processing device according to (28) described above in which the shooting-related information includes shooting position information relating to a position of a camera that has taken the image.

(30)

The information processing device according to (28) or (29)

described above in which the shooting-related information includes shooting direction information relating to a direction of a camera that has taken the image.

(31)

The information processing device according to any one of (28) to (30) described above in which the shooting-related information includes shooting angle-of-view information relating to an angle of view of a camera that has taken the image.

(32)

The information processing device according to any one of (25) to (31) described above in which the viewpoint switch information includes reference angle-of-view information relating to an angle of view of a screen referred to when position information of an audio object relevant to a viewpoint that is associated with the viewpoint switch information has been determined.

(33)

An information processing method that is performed by an information processing device, the method including acquiring a metadata file that includes viewpoint switch information to perform a position correction of an audio object at a viewpoint switch among plural viewpoints.

(34)

A program that causes a computer to implement a function of acquiring a metadata that includes viewpoint switch information to perform a position correction of an audio object at a viewpoint switch among plural viewpoints.

### REFERENCE SIGNS LIST

100 GENERATING DEVICE
110 GENERATING UNIT
111 IMAGE-STREAM ENCODING UNIT
112 AUDIO-STREAM ENCODING UNIT
113 CONTENT-FILE GENERATING UNIT
114 METADATA-FILE GENERATING UNIT
200 DISTRIBUTION SERVER
300 CLIENT
310 PROCESSING UNIT
311 METADATA-FILE ACQUIRING UNIT
312 METADATA-FILE PROCESSING UNIT
313 SEGMENT-FILE-SELECTION CONTROL UNIT
321 SEGMENT-FILE ACQUIRING UNIT
323 FILE PARSING UNIT
325 IMAGE DECODING UNIT
327 RENDERING UNIT
329 OBJECT RENDERING UNIT
330 AUDIO PROCESSING UNIT
331 SEGMENT-FILE ACQUIRING UNIT
333 FILE PARSING UNIT
335 AUDIO DECODING UNIT
337 OBJECT-POSITION CORRECTING UNIT
339 OBJECT RENDERING UNIT
340 CONTROL UNIT
350 COMMUNICATION UNIT
360 STORAGE UNIT
400 OUTPUT DEVICE
600 GENERATING DEVICE
610 GENERATING UNIT
611 IMAGE-STREAM ENCODING UNIT
612 AUDIO-STREAM ENCODING UNIT
613 CONTENT-FILE GENERATING UNIT
700 STORAGE DEVICE
710 GENERATING UNIT
713 CONTENT-FILE GENERATING UNIT
800 REPRODUCING DEVICE
810 PROCESSING UNIT
820 IMAGE PROCESSING UNIT
821 FILE ACQUIRING UNIT
823 FILE PARSING UNIT
825 IMAGE DECODING UNIT
827 RENDERING UNIT
830 AUDIO PROCESSING UNIT
831 FILE ACQUIRING UNIT
833 FILE PARSING UNIT
835 AUDIO DECODING UNIT
837 OBJECT-POSITION CORRECTING UNIT
839 OBJECT RENDERING UNIT
840 CONTROL UNIT
850 COMMUNICATION UNIT
860 STORAGE UNIT

1. An information processing device comprising
a metadata-file generating unit that generates a metadata file including viewpoint switch information to perform a position correction of an audio object at a viewpoint switch among a plurality of viewpoints.

2. The information processing device according to claim 1, wherein
the metadata file is a media presentation description (MPD) file.

3. The information processing device according to claim 2, wherein
the viewpoint switch information is stored in AdaptationSet in the MPD file.

4. The information processing device according to claim 2, wherein
the viewpoint switch information is stored in Period in the MPD file, associated with AdaptationSet in the MPD file.

5. The information processing device according to claim 1, wherein
the metadata-file generating unit further generates a media presentation description (MPD) file including access information to access the metadata file.

6. The information processing device according to claim 5, wherein
the access information is stored in AdaptationSet in the MPD file.

7. The information processing device according to claim 5, wherein
the access information is stored in Period in the MPD file, associated with AdaptationSet in the MPD file.

8. The information processing device according to claim 1, wherein
the viewpoint switch information is stored in the metadata file, associated with each viewpoint included in the plurality of viewpoints.

9. The information processing device according to claim 8, wherein
the viewpoint switch information includes switch-destination viewpoint information related to a switch destination viewpoint switchable from a viewpoint associated with the viewpoint switch information.

10. The information processing device according to claim 9, wherein
the viewpoint switch information includes threshold information relating to a threshold for a switch to the switch destination viewpoint from a viewpoint associated with the viewpoint switch information.

11. The information processing device according to claim 8, wherein
the viewpoint switch information includes shooting-related information of an image relevant to a viewpoint associated with the viewpoint switch information.

12. The information processing device according to claim 11, wherein
the shooting-related information includes shooting position information relating to a position of a camera that has taken the image.

13. The information processing device according to claim 11, wherein
the shooting-related information includes shooting direction information relating to a direction of a camera that has taken the image.

14. The information processing device according to claim 11, wherein
the shooting-related information includes shooting angle-of-view information relating to an angle of view of a camera that has taken the image.

15. The information processing device according to claim 8, wherein
the viewpoint switch information includes reference angle-of-view information relating to an angle of view of a screen referred to when position information of an audio object relevant to a viewpoint that is associated with the viewpoint switch information has been determined.

16. An information processing method that is performed by an information processing device, the method comprising
generating a metadata file that includes viewpoint switch information to perform a position correction of an audio object at a viewpoint switch among a plurality of viewpoints.

17. A program that causes a computer to implement a function of
generating a metadata that includes viewpoint switch information to perform a position correction of an audio object at a viewpoint switch among a plurality of viewpoints.
